SEQUENCE LISTING (11 sequences)

SEQ ID NO: 1 - protein, 35 aa, Homo sapiens
CGSVPHDTWLPKKCSLCKCWHGQLRCFPQAFLPGC

SEQ ID NO: 2 - protein, 82 aa, Homo sapiens
CESIMRRRGLTSPCKDINTFIHGNKRSIKAICENKNGNPHRENLRISKSSFQVTTCKLHGGSPWPPCQYRATAGFRNVVVAC

SEQ ID NO: 3 - protein, 89 aa, Homo sapiens
CTIAMRAINNYRWRCKNQNTFLRTTFANVVNVCGNQSIRCPHNRTLNNCHRSRFRVPLLHCDLINPGAQNISNCRYADRPGRRFYVVAC

SEQ ID NO: 4 - protein, 68 aa, Homo sapiens
CNQMMKSRNLTQNRCKPVNTFVHESLADVQAVCSQKNVACKNGQTNCYQSYSTMSITDCRETGSSKYP

SEQ ID NO: 5 - protein, 84 aa, Homo sapiens
CDSAMRDINKHTKRCKDLNTFLHKPFSSVAATCQTPNITCKNGHKNCHQSHRPVSLTMCGLTSGKYPNCRYKEEHQNKSYVVAC

SEQ ID NO: 6 - protein, 78 aa, Homo sapiens
CNVMMVRRGMTAHGRCKSFNTFVHTDPRNLNTLCINQPDQALRTTRRHFRITDCKLIRSHPTCRYSGNQFNRRVRVGC

SEQ ID NO: 7 - protein, 87 aa, Homo sapiens
CDDAMRVVNRYTGKCKDLNTFLHTTFADAVRVCHNPRKTCKDGTSPNCHDSSSKVSVTICKLTKRARNYSQCRYKTTGAEKSYTVAC

SEQ ID NO: 8 - protein, 88 aa, Homo sapiens
CNVEMQRINRFRRTCKGLNTFLHTSFANAVGVCGNPSGLYNDNISRNCHNSSSRVRTTVCNITSRRRTPYTQCRYQPRRSLEYYTVAC

SEQ ID NO: 9 - protein, 86 aa, Homo sapiens
CTPAMKGVNNYTGRCKNINTFLNTSFAAVVSVCGNKNTTCRNGHTNCHNSSAPVSLTYCNLTTWSSNYTQCRYQTTPATKFYRIAC

SEQ ID NO: 10 - protein, 89 aa, Homo sapiens
CTNAMRVINNYQRRWKNRNTFLLATFANVVNVCGNPTITCPHNRTLNNCHHSGVQVPLMYCNLTTPSPQNISNCRYAQTPANMFYIVAC

SEQ ID NO: 11 - protein, 85 aa, Homo sapiens
CNLMMFCQKMTQGKCKPVNTFVHESLADVKAVCSQKKVTCKNGQTNRYQSKSTMRITDCRETGSSKYPNCAYKTTQVEKRIIVAC

(19) United States
(12) Patent Application Publication
(10) Pub. No.: US 2007/0088506 A1
(43) Pub. Date: Apr. 19, 2007

(54) Detecting protein similarity

(75) Inventors: Juswinder Singh, Ashland, MA (US); Herman Van Vlijmen, Somerville, MA (US); Abhas Gupta, Wheeling, WV (US)

Correspondence Address: STEPTOE & JOHNSON LLP, 1330 CONNECTICUT AVENUE, N.W., WASHINGTON, DC, 20036, US

(73) Assignee: Biogen Idec MA Inc., Cambridge, MA (US)

(21) Appl. No.: 10/580,040

(22) PCT Filed: Nov. 23, 2004
(86) PCT No.: PCT/US04/39326

§ 371 Date: Nov. 20, 2006

Related U.S. Application Data
(60) Provisional application No. 60/524,084, filed on Nov. 24, 2003.

(51) Int. Cl. G06F 19/00

(52) U.S. Cl. 702/19

(57) ABSTRACT

The disulfide bridges in a protein sequence can be described by a disulfide signature that includes information about cysteine spacing and disulfide topology. Proteins with similar disulfide signatures can be structurally similar despite low overall sequence homology. A database of disulfide signatures can be compiled from publicly available sequence data.

### TECHNICAL FIELD

This invention relates to detecting protein sequence similarity.

### BACKGROUND

Disulfide bridges, formed by the covalent cross-linking of cysteine residues, act as structural elements that can stabilize the tertiary structure of proteins. In addition, disulfide bridges can play a vital role in the folding of many proteins. Disulfide bridges can also have functional roles in proteins.

A method of detecting protein similarity can include finding similar disulfide signatures between two proteins. Despite the growth of protein sequence databases and the large number of sequence search tools, as yet no tool exists to find similarities between the disulfide bonding patterns of homologous proteins. An approach for identifying proteins having similar disulfide signatures can include building a database of experimentally determined and inferred disulfide signatures. An associated search tool can be used to search the database for similar disulfide signatures.

A disulfide signature is a representation of an amino acid sequence and structure that includes information about cysteine spacing in the amino acid sequence and disulfide bridges between pairs of cysteine residues. A disulfide signature and similarity measure provide a fast and straightforward way to identify protein sequences that have a similar disulfide bridge topology and cysteine spacing. A database including disulfide signatures, and an associated search tool, can facilitate finding structurally related proteins through identification of similar disulfide signatures. The database can include signatures for many proteins with unknown functions. For example, structural and functional relationships between sets of proteins can be identified based on relative disulfide signature similarities. The database and search tool can be used in assigning structures of cysteine-rich proteins and in other structural genomics efforts. The disulfide signatures in the database can be classified by disulfide signatures to group together proteins with related structures and functions.

In one aspect, a method of detecting similarity between protein sequences includes comparing a first disulfide signature to a second disulfide signature.

In another aspect, a method of detecting similarity between protein sequences includes generating a database including a plurality of disulfide signatures and comparing a first disulfide signature corresponding to a protein sequence to at least one disulfide signature of the database.

In another aspect, a method of detecting similarity between protein sequences includes generating a database including a plurality of disulfide signatures.

Each disulfide signature is characteristic of a corresponding protein sequence. Each disulfide signature can describe a disulfide topology of the corresponding protein sequence. Each disulfide signature can include the number of residues between a pair of cysteines joined by a disulfide bridge, and the number of residues between the first cysteine of each disulfide bridge and the first cysteine of the next disulfide bridge in the corresponding protein sequence. Each disulfide signature can include the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

Comparing can include calculating a measure of similarity between the first disulfide signature and the second disulfide signature. Comparing can include calculating a measure of statistical relevance for the measure of similarity between the first disulfide signature and the second disulfide signature. Comparing can include searching a database including a plurality of disulfide signatures, each disulfide signature of the database characteristic of a corresponding protein sequence. Comparing can include calculating a measure of similarity between the first disulfide signature and each of a plurality of disulfide signatures of the database.

Searching the database can include searching with a subpattern of the first disulfide signature. The subpattern can be generated by calculating the disulfide signature that results when one or more disulfide bridges is removed from the protein sequence corresponding to the first disulfide signature. At least one disulfide signature in the database can be associated with a sequence identifier. At least one disulfide signature in the database can be associated with a domain identifier.

The method can include clustering disulfide signatures of the database. Clustering can include grouping disulfide signatures by number of disulfide bridges. Clustering can include grouping disulfide signatures by disulfide topology. Clustering can include calculating a measure of similarity between disulfide signatures and grouping based on the measure of similarity.

Generating the database can include identifying a disulfide bridge by experimental disulfide determination, protein sequence homology or protein structure homology. Generating the database can include calculating a disulfide signature for a protein sequence or protein domain. Calculating the disulfide signature can include determining the number of residues between a pair of cysteines joined by a disulfide bridge in the protein sequence. Calculating the disulfide signature can include determining the number of residues between the first cysteine of each disulfide bridge and the first cysteine of the next disulfide bridge in the protein sequence.

In another aspect, a computer program for detecting similarity between protein sequences includes instructions for causing a computer system to compare a first disulfide signature to a second disulfide signature, each disulfide signature being characteristic of a corresponding protein sequence.

In another aspect, a computer-readable data storage medium includes a data storage material encoded with a computer-readable database, the database including a plurality of disulfide signatures, each disulfide signature of the database characteristic of a corresponding protein sequence.

The data storage medium can be encoded with a computer program including instructions for causing a computer system to compare a first disulfide signature to a second disulfide signature, each disulfide signature being characteristic of a corresponding protein sequence.

In yet another aspect, a method of describing a protein sequence includes generating a first disulfide signature, the disulfide signature-describing the cysteine spacing and disulfide topology of first a protein sequence.

As the number of experimentally determined disulfide bridges continues to increase, e.g. through structural genomics efforts and recent advances in mass spectrometry techniques for disulfide determination, a disulfide signature database will become an increasingly powerful tool for the discovery of protein structural homologs.

The details of one or more embodiments are set forth in the accompanying drawings and the description below. Other features, objects, and advantages will be apparent from the description and drawings, and from the claims.

### DESCRIPTION OF DRAWINGS

FIG. 1A is a schematic diagram illustrating construction of a disulfide database. FIG. 1B is an illustration of a method of inferring the location of disulfides bridges in protein sequences.

FIG. 2 is a graph depicting the number of sequences in databases having different number of disulfide bridges.

FIG. 3A is a graph showing the distribution of distances between disulfide signatures of related and unrelated sequences. FIG. 3B is a graph of the cumulative fraction of distances between disulfide signatures of related and unrelated sequences.

FIG. 4 is a graph showing the relationship between disulfide signature length and the 99% probability of two disulfide signatures being related.

FIGS. 5A and 5B are parallel plots for clusters of disulfide signatures.

FIG. 6 is a drawing of the structures of two similar proteins which have similar disulfide signatures.

FIG. 7 is a drawing of the structures of two similar proteins which have similar disulfide signatures.

FIG. 8A is a depiction of a disulfide classification wheel. FIG. 8B shows the annotation for one cluster of the wheel.

FIG. 9 is a schematic drawing describing the relationship between protein domains and clusters of a disulfide classification wheel.

FIGS. 10A, 10B and 10C are depictions of disulfide classification wheels.

FIG. 11A is a parallel plot for a cluster of disulfide signatures. FIG. 11B is a drawing of protein structures for proteins belonging to the cluster.

FIG. 12 is a drawing of the structures of three similar proteins.

FIGS. 13A and 13B are drawings of disulfide classification wheels with links. FIG. 13C is a depiction of protein sequences with disulfide bridges.

### DETAILED DESCRIPTION

Disulfide bridges, formed by the covalent cross-linking of cysteine residues, are found in prokaryotic and eukaryotic proteins. These structural elements are mostly found in non-reducing environments (see Thornton, J. M. J. Mol. Biol. (1981) 151, 261-287; and Fiser, A. & Simon, I. Bioinformatics (2000) 16, 251-256, each of which is incorporated by reference in its entirety), and have been shown to provide significant stabilization to the tertiary folds of proteins. See, for example, Creighton, T. E. Bioessays (1988) 8, 57-63, which is incorporated by reference in its entirety. Slightly over 10% of SwissProt protein sequences include disulfide bridge annotations; disulfide bridges therefore constitute a commonly occurring post-translational modification of proteins (see Boeckmann, B. et al., Nucleic Acids Res. (2003) 31, 365-370, which is incorporated by reference in its entirety). Each SwissProt protein sequence entry includes annotations that describe, for example, post-translational modification to the protein, including disulfide bridges, phosphorylation sites, glycosylation sites, and others.

In conserved protein structures, the connectivity and conformational properties of disulfide bridges can be conserved, as can be the locations of cysteine residues in groups of homologous proteins. The loss of a disulfide bridge is usually associated with mutation of not one but both cysteine residues. The occurrences of disulfide connectivities are non-random and it has been suggested that disulfide bridge formation is a directed process (see Benham, C. J. & Jafri, M. S. Protein Sci. (1993) 2, 41-54, which is incorporated by reference in its entirety). Analysis of disulfide connectivities in the context of sequence length revealed that an entropic stabilization model determines the disulfide connectivity for short proteins, whereas a diffusion model can better describe the disulfide connectivities for longer sequences (see Harrison, P. M. & Sternberg, M. J. J. Mol. Biol. (1994) 244, 448-463, which is incorporated by reference in its entirety). For example, the evolutionary relationship between snail and spider toxins, which is not obvious from the sequence similarity, was recognized by identifying the strong conservation of disulfide frameworks (see Narasimhan, L., et al.. Nat. Struct. Biol. (1994) 1, 850-852, which is incorporated by reference in its entirety). This concept was expanded to group disulfide-containing protein structures based on the three-dimensional superposition of their disulfide bonds. Although applied to a small set of structures, the results suggest a strong conservation of disulfide bonds even in the absence of significant sequence homology (see Mas, J. M., et al., J. Comput. Aided. Mol. Des. (2001) 15, 477-487, which is incorporated by reference in its entirety).

The disulfide signature of a protein includes both the cysteine spacing and disulfide topology. The cysteine spacing is the number of residues in an amino acid sequence between a pair of cysteines that forms a disulfide bridge. The disulfide topology denotes the connectivity of the cysteines involved in disulfide bridges. For example, a protein with two disulfides has three possible topologies: 1-2_{—}3-4 (also written as aabb), 1-3_{—}2-4 (abab), or 1-4_{—}2-3 (abba). The numbers in the disulfide topologies correspond to the sequential numbering of the cysteine residues in the protein sequence (from the N-terminus) and the dashes represent bonds between those cysteines. The number of possible disulfide topologies rapidly increases with the number of disulfides (Benham, C. J. & Jafri, M. S. Protein Sci. (1993) 2, 41-54). Similarity in disulfide signatures reflects similarity in both disulfide topology and cysteine spacing.

A disulfide signature of a protein sequence can be described numerically, for example, as a string of numbers representing the cysteine spacing pattern. A numeric description of a disulfide pattern can also include information describing the disulfide topology.

The cysteine spacing pattern is a string of residue spacings between adjacent disulfide-linked cysteines of a protein, starting with the first cysteine and continuing along to the last cysteine in the sequence (Scheme 1). In Scheme 1, the brackets above the sequence represent disulfide bridges. For example, for the sequence in Scheme 1, the cysteine spacing pattern is as follows: (14−1)-(17−14)-(19−17)-(26−19)-(35−26)=13-3-2-7-9.

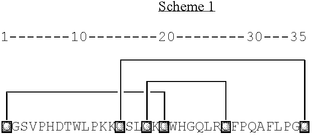

The cysteine spacing pattern is a set of (2n−1) numbers, where n is the number of disulfides bridges in the protein. This representation does not encompass any cysteine connectivity information and therefore only captures one characteristic of a disulfide pattern. It is possible to search a protein sequence database for a cysteine spacing pattern with standard query methods, such as FASTA or BLAST, using scoring matrices in which cysteine residues have strongly increased weights (see, for instance, Karlin, S. & Altschul, S. F. Proc. Natl. Acad. Sci. USA (1990) 87, 2264-2268, which is incorporated by reference in its entirety).

To incorporate disulfide topology into a search, a disulfide signature can implicitly contain disulfide topology. For the sequence in Scheme 1, the topology is 1-4_{—}2-6_{—}3-5. For a protein with known disulfide topology and cysteine spacings, the disulfide pattern can be expressed as a disulfide signature, which is a string of numbers, where the first number is the length of the first disulfide bridge, the second number is the spacing between the first residue of the first disulfide and the first residue of the second disulfide, the third number is the length of the second disulfide bridge, and so on, until the last number of the pattern, which is the length of the last disulfide bridge. For example, the disulfide signature of the sequence in Scheme 1 is: (19−1)-(14−1)-(35−14)-(17−14)-(26−17)=18-13-21-3-9. Other numerical expressions of a disulfide signature can be created. For example, the signature could list all disulfide bridge lengths first, then the distances between the first cysteine in each disulfide bridge.

Two sequences that have the same cysteine spacing pattern but different topologies can be distinguished by the disulfide signature. For example, if the sequence in Scheme 1 had the topology 1-3_{—}2-5_{—}4-6, as shown in Scheme 2, then the disulfide signature would be 16-13-12-5-16, even though the cysteine spacing pattern is unchanged.

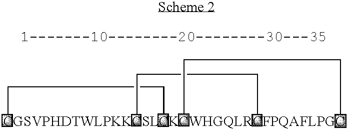

The odd positions in the disulfide signature correspond to disulfide bridge lengths and the even positions correspond to spacings between the first residues (relative to the N-terminus) in neighboring disulfide bridges. As with the cysteine spacing pattern, the disulfide signature contains (2n−1) numbers, where n is the number of disulfide bridges. The disulfide topology and the cysteine spacing pattern can be reconstructed from the disulfide signature.

The similarity between two disulfide signatures (or between two cysteine spacing patterns) can be described by a distance measure. The distance dₘₙ between the disulfide signatures m and n can be defined by Eq. 1:
dₘₙ=\sqrt{Σ(mᵢ−nᵢ)²} (Eq. 1)
where the index i sums over all numbers in the signature. Both cysteine patterns must have the same number of disuifide bonds in order to calculate a distance with this definition. Shorter distances indicate higher degrees of similarity between the disulfide signatures.

A database can include disulfide patterns, such as disulfide signatures. The database can include entries for multiple protein sequences, each sequence associated with a disulfide signature or other disulfide pattern. Each protein sequence entry in the database can include a disulfide signature and one or more identifiers. The identifier can be an identifier used in a publicly available database, such as, for example, SwissProt, TrEMBL, PDB, PIR, or others. The identifier can be unique to a particular protein sequence, or can refer to a group of protein sequences, such as a family of related protein sequences. The protein sequence can be a partial protein sequence, for example, the sequence of one domain of a multidomain protein. The entries in the database can include other information about the disulfides in a sequence, such as the disulfide topology, the residue numbers of cysteines involved in disulfide bridges, the cysteine spacing, or the number of disulfide bridges in the sequence.

The disulfide signatures in the database can be calculated from publicly available sequence data annotated to indicate the location of disulfide bridges. The annotations can be based on experimental evidence. The locations of additional disulfide bridges can be inferred based on sequence homology to sequences with experimentally determined disulfide bridges.

In SwissProt, inferred disulfide bridge annotations are only assigned when a protein sequence has a clear sequence homology to another protein with experimentally determined disulfide bridges. Although the number of disulfide bridge annotations added to SwissProt by this method is quite large, there exist many more proteins for which the presence and location of disulfide bridges can be inferred based on overall sequence homology. To expand the set of disulfide signatures in the database, the annotations in a public database, such as SwissProt, can be combined with the multiple sequence alignments, for example the alignments in the Pfam database (see Bateman, A., et al., Nucleic Acids Res. (2002) 30, 276-280, which is incorporated by reference in its entirety). Pfam is a database of multiple alignments of protein domains or conserved protein regions. The alignments represent some evolutionary conserved structure which has implications for the function of the protein. Because Pfam is based on multiple alignments of domains (rather than full-length protein sequences), a particular SwissProt sequence can include more than one Pfam domain. The SwissProt database contains annotations of both experimentally determined disulfide bridges and inferred disulfide bridges (see Boeckmann, B. et al., Nucleic Acids Res. (2003) 31, 365-370, which is incorporated by reference in its entirety).

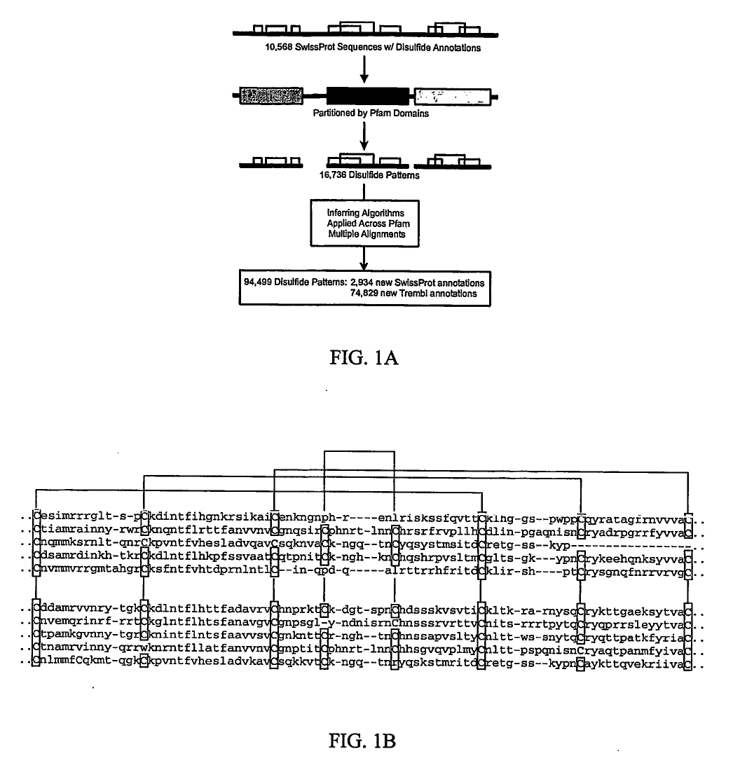

The process inferring additional disulfides with the aid of Pfam multiple alignments is illustrated in FIG. 1A. Sequences including disulfide bridge annotations, such as SwissProt sequences, are divided according to Pfam domains, and compared to multiply-aligned homologous protein sequences. Since the Pfam multiple alignments contain SwissProt protein identifiers, the mapping of disulfide-containing proteins to Pfam domains is relatively straightforward. A disulfide bridge annotation is made to an unannotated sequence in a multiple alignment when it has cysteine residues in both positions corresponding to a disulfide bridge in a homologous, annotated sequence.

SwissPfam, a component of the Pfam database, can be used to identify segments of disulfide-containing sequences that corresponded to Pfam-A or Pfam-B domains. Both Pfam-A and Pfam-B multiple alignments contain-SwissProt and TrEmbl sequences; however, Pfam-A alignments are hand-curated and Pfam-B alignments are automatically generated. For a subset of Pfam family multiple alignments (both Pfam-A and Pfam-B), there are sequences in the alignment that are present in SwissProt with annotated disulfides (see Corpet, F., Gouzy, J. & Kahn, D. Nucleic Acids Res. (1998) 26, 323-326, which is incorporated by reference in its entirety). In many cases, more than one protein in a given Pfam domain family has disulfide annotations in SwissProt, sometimes at different sequence positions or with different connectivity patterns.

As SwissProt sequences often contain multiple Pfam domains, the SwissProt-extracted disulfide signatures can be subdivided according to the Pfam domain segments from which they originate. Only disulfide bridges where both cysteines of the disulfide bridge occur completely inside or outside Pfam domains are retained; all other disulfide bridges are regarded as interdomain and discarded. The disulfide bridges in a sequence occurring outside Pfam domains are grouped together across each individual sequence, assigned as belonging to the “NULL” domain, and appended to the database as independent disulfide signatures.

The residue columns of the multiple alignments corresponding to the cysteines of experimentally determined disulfide bridges can be determined, and a cumulative set of disulfide bridges defined for the multiple alignment of the Pfam domain family. For sequences in the multiple alignment without disufide bridge annotations, disulfide bridges can be assigned when cysteine residues are present at both positions of any of the cumulative set of disulfide bridges. These inferred disulfide signatures can be distinguished from experimentally determined disulfide bridges in the database, for example, by appending ‘X’ to the end of the Pfam family from which they were derived. Inferred signatures that exhibited any ambiguities such as two or more disulfide bridges sharing a common cysteine are ignored.

FIG. 1B represents an illustration of the disulfide inference :method. The top five sequences are from Pfam domain PF00074 (pancreatic ribonuclease) and have disulfide bridge annotations, indicated by above connecting lines. Positions considered for disulfide bridge annotation are boxed. The bottom five sequences belong to the same Pfam domain, but have no disulfide bridge annotations. Cysteines of the inferred disulfide bridges are also boxed. Note that in unannotated sequences two and four, one of the disulfide-participating cysteines has mutated to a non-cysteine residue.

The cysteine spacing patterns and disulfide signatures of all disulfide bridges defined in SwissProt and inferred from Pfam multiple sequence alignments can be stored in a database. As there are many cases of proteins within the same family differing in the number of disulfide bridges, a search tool for the database can include the option of searching against one, more than one, or all of the subpatterns of every disulfide signature in the database. The search tool can include the option to search with one, more than one, or all of the subpatterns of the query. A subpattern is defined as the cysteine spacing pattern or disulfide signature that results from the removal of one or more disulfide bridges from an original sequence. When a subpattern search is invoked, the complete set of subpatterns resulting from the removal of one or more disulfide bridges can be calculated at execution time, for each pattern in the database and/or for the query pattern.

The SwissProt database Release 40.41 (March 2003) contains a total of 41,846 annotated disulfide bridges, of which 5,045 are experimentally determined and 34,968 are inferred by sequence similarity. Of these, 1,694 disulfides are annotated as interchain, which connect separate protein domains, and are not included in a database of disulfide signatures. For 139 disulfides, the annotations are ambiguous or erroneous, e.g., the disulfide residue numbers do not correspond to cysteine residues. The number of proteins with annotated disulfide bridges is 10,568, which constitutes 8.6% of the total number of proteins in SwissProt. Of the 10,568 proteins, 1,689 are annotated with experimentally determined disulfide bridges, 8,739 with inferred disulfide bridges, and 140 with a combination of experimental and inferred disulfide bridges. The structures of many of the proteins with annotated disulfide bridges in SwissProt have been determined with X-ray crystallography or nuclear magnetic resonance spectroscopy (NMR).

The 10,568 disulfide-containing proteins from SwissProt map to 13,408 domains in the Pfam-A database, corresponding to 345 different Pfam protein families, and 814 in the Pfam-B database, corresponding to 288 families. The number of Pfam domains is larger than the number of SwissProt entries because many proteins contain multiple Pfam domains. Of the disulfide-containing SwissProt annotated sequences, the disulfide-containing portion is absent from Pfam in 2,514 cases, which are assigned to the NULL domain. Combining the Pfam-A, Pfam-B, and unassigned domains results in a total of 16,736 domains, which can be regarded as the publicly annotated number of disulfide-containing protein domains.

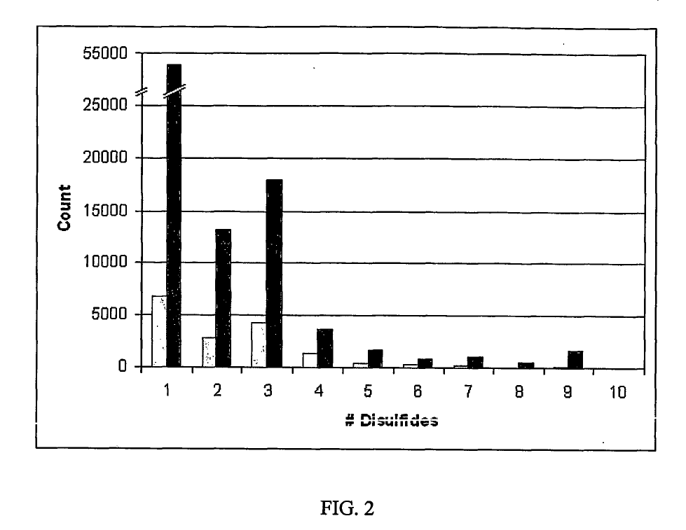

Application of the inferring algorithms outlined above can increase the disulfide database with 77,763 additional Pfam protein domains, expanding the database fom 16,736 to 94,499 disulfide-containing protein domains. FIG. 2 shows the distribution of the database contents by number of disulfide bridges. Light bars represent the number of annotated domains in SwissProt, and dark bars represent the number of newly annotated domains in the database. 2,934 sequences newly annotated in the inferring process correspond to SwissProt sequences that are either partially or completely lacking in their disulfide annotation. The remaining newly annotated sequences correspond to TrEMBL sequences that have very limited structural annotation.

By way of example, a portion of a disulfide database is presented in Table 1. The database includes several different descriptions of te disulfide pattern for each protein sequence represented in the database. Each entry in the database includes a disulfide signature as defined above; an expanded signature that includes cysteine residue numbers ordered according to the disulfide topology, the cysteine spacing pattern; the disulfide topology; the domain class (i.e. the Pfam family); the protein name (i.e. the SwissProt name for the full length sequence); the bounds of the domain (i.e. the start and stop positions for the domain in the full length sequence); and the count of disulfide bridges in the domain. The different representations of the disulfide pattern can include redundant information. For example the disulfide signature includes information about the disulfide topology. A database search can be performed using one or more of the representations. For example, a search could be performed using the disulfide signature alone, or with a combination of the cysteine spacing pattern and the topology.

The inference method also revealed 65 domain families in which the disulfide bridges could not be unambiguously assigned. This situation occurs, for instance, when a cysteine residue at a given position is involved in multiple disulfide bridges across different proteins in a Pfam domain family. Preliminary analysis showed that in several cases the disulfide bridge annotation in SwissProt was incorrect, but in other cases this ambiguity may be caused by a true plasticity of disulfide bridges within the Pfam profile.

TABLE 1

| Disulfide | Expanded | | Disulfide | Domain | | | |
|---|---|---|---|---|---|---|---|
| Signature | Signature | Cysteine Spacing | Topology | Class | Protein Name | Bounds | Count |
| 66-29-69-4-67 | 323-389-352- | 29-4-33-32-2 | 1-4_2-5_3-6 | PF00019 | BM10_HUMAN | 320-424 | 3 |
| | 421-356-423 | | | | | | |
| 66-29-69-4-67 | 319-385-348- | 29-4-33-32-2 | 1-4_2-5_3-6 | PF00019 | BM10_MOUSE | 316-420 | 3 |
| | 417-352-419 | | | | | | |
| 66-29-69-4-67 | 291-357-320- | 29-4-33-32-2 | 1-4_2-5_3-6 | PF00019 | BM15_HUMAN | 288-392 | 3 |
| | 389-324-391 | | | | | | |
| 66-29-69-4-67 | 291-357-320- | 29-4-33-32-2 | 1-4_2-5_3-6 | PF00019 | BM15_MOUSE | 288-392 | 3 |
| | 389-324-391 | | | | | | |
| 66-29-69-4-67 | 292-358-321- | 29-4-33-32-2 | 1-4_2-5_3-6 | PF00019 | BM15_SHEEP | 289-393 | 3 |
| | 390-325-392 | | | | | | |
| 67-29-70-4-68 | 376-443-405- | 29-4-34-32-2 | 1-4_2-5_3-6 | PF00019 | BM3B_HUMAN | 373-478 | 3 |
| | 475-409-477 | | | | | | |
| 67-29-70-4-68 | 374-441-403- | 29-4-34-32-2 | 1-4_2-5_3-6 | PF00019 | BM3B_MOUSE | 371-476 | 3 |
| | 473-407-475 | | | | | | |
| 67-29-70-4-68 | 374-441-403- | 29-4-34-32-2 | 1-4_2-5_3-6 | PF00019 | BM3B_RAT | 371-476 | 3 |
| | 473-407-475 | | | | | | |
| 14-8-15-17-11- | 255-269-263- | 8-6-9-2-11-4-5-7-9- | 1-3_2-4_5- | NULL | BM86_BOOMI | 0-0 | 7 |
| 15-12-5-16- | 278-280-291- | 170-14-18-11 | 6_7-9_8- | | | | |
| 186-14-32-11 | 295-307-300- | | 10_11- | | | | |
| | 316-486-500- | | 12_13-14 | | | | |
| | 518-529 | | | | | | |
| 13-8-17-19-14 | 24-37-32-49- | 8-5-12-2-14 | 1-3_2-4_5-6 | PF00008 | BM86_BOOMI | 24-65 | 3 |
| | 51-65 | | | | | | |
| 10-5-15-17-10 | 71-81-76-91- | 5-5-10-2-10 | 1-3_2-4_5-6 | PB041743 | BM86_BOOMI | 66-144 | 3 |
| | 93-103 | | | | | | |
| 13-9-13-15-13 | 209-222-218- | 9-4-9-2-13 | 1-3_2-4_5-6 | PF00008 | BM86_BOOMI | 209-246 | 3 |
| | 231-233-246 | | | | | | |
| 16 | 318-334 | 16 | 1-2 | PB072769 | BM86_BOOMI | 302-488 | 1 |
| 24 | 492-516 | 24 | 1-2 | PB049270 | BM86_BOOMI | 489-517 | 1 |
| 15-8-16 | 535-550-543- | 8-7-9 | 1-3_2-4 | PB049274 | BM86_BOOMI | 532-560 | 2 |
| | 559 | | | | | | |
| 6 | 561-567 | 6 | 1-2 | PB058259 | BM86_BOOMI | 561-650 | 1 |
| 66-29-69-4-67 | 298-364-327- | 29-4-33-32-2 | 1-4_2-5_3-6 | PF00019 | BM8A_MOUSE | 295-399 | 3 |
| | 396-331-398 | | | | | | |
| 66-29-69-4-67 | 298-364-327- | 29-4-33-32-2 | 1-4_2-5_3-6 | PF00019 | BM8B_MOUSE | 295-399 | 3 |
| | 396-331-398 | | | | | | |
| 3 | 183-186 | 3 | 1-2 | PF01400 | BMP1_HUMAN | 128-321 | 1 |
| 26-53-22 | 322-348-375- | 26-27-22 | 1-2_3-4 | PF00431 | BMP1_HUMAN | 322-431 | 2 |
| | 397 | | | | | | |
| 26-53-22 | 435-461-488- | 26-27-22 | 1-2_3-4 | PF00431 | BMP1_HUMAN | 435-544 | 2 |
| | 510 | | | | | | |
| 12-8-13-15-13 | 551-563-559- | 8-4-9-2-13 | 1-3_2-4_5-6 | PF00008 | BMP1_HUMAN | 551-587 | 3 |
| | 572-574-587 | | | | | | |
| 26-53-22 | 591-617-644- | 26-27-22 | 1-2_3-4 | PF00431 | BMP1_HUMAN | 591-700 | 2 |
| | 666 | | | | | | |
| 11-7-13-15-13 | 707-718-714- | 7-4-9-2-13 | 1-3_2-4_5-6 | PF00008 | BMP1_HUMAN | 707-742 | 3 |
| | 727-729-742 | | | | | | |
| 3 | 188-191 | 3 | 1-2 | PF01400 | BMP1_MOUSE | 133-326 | 1 |
| 26-53-22 | 327-353-380- | 26-27-22 | 1-2_3-4 | PF00431 | BMP1_MOUSE | 327-436 | 2 |
| | 402 | | | | | | |
| 26-53-22 | 440-466-493- | 26-27-22 | 1-2_3-4 | PF00431 | BMP1_MOUSE | 440-549 | 2 |
| | 515 | | | | | | |
| 12-8-13-15-13 | 556-568-564- | 8-4-9-2-13 | 1-3_2-4_5-6 | PF00008 | BMP1_MOUSE | 556-592 | 3 |
| | 577-579-592 | | | | | | |
| 26-53-22 | 596-622-649- | 26-27-22 | 1-2_3-4 | PF00431 | BMP1_MOUSE | 596-705 | 2 |
| | 671 | | | | | | |
| 11-7-13-15-13 | 712-723-719- | 7-4-9-2-13 | 1-3_2-4_5-6 | PF00008 | BMP1_MOUSE | 712-747 | 3 |
| | 732-734-747 | | | | | | |
| 3 | 146-149 | 3 | 1-2 | PF01400 | BMP1_XENLA | 91-284 | 1 |

The database and an associated search tool can be used to find the proteins with the most similar disulfide signatures to a given query disulfide signature. To define the distance d at which the similarity is statistically significant, distance distributions can be generated by calculating the distances between a large number (for example, 100,000) of pairs of random disulfide signatures. To construct the random disulfide signatures, the mᵢ and nᵢ values (see Eq.1) can be chosen randomly from the collection of all spacings in the set of proteins with the corresponding number of disulfide bridges. A separate distribution can be calculated for each different number of disulfide bridges.

The distance distributions depend on the length of the disulfide signature. The length L of a disulfide signature m can be defined according to Eq. 2.
L=\sqrt{Σmᵢ²} (Eq.2)
where the index i sums over all numbers in the signature. For example, the random distance distribution to a short disulfide signature (i.e., a disulfide signature with relatively short cysteine spacings), for example 5-2-6-4-8 (L=12.0), is centered at a significant lower value than the distribution of a long disulfide signature (i.e., a pattern with relatively long cysteine spacings), for example 25-10-18-7-35 (L=48.2). To account for the dependence of disulfide signature distance on L, the generated distributions can be divided into equally populated sets of distances (for example, 10 sets of 10,000 distances each) based on the vector length L of the mᵢ values of the random pairs. Because the distance distributions are based on random disulfide signatures, they can signify false positive distance values. The integration of normalized distance distributions can be used to assign the statistical significance values to different disulfide signature similarity scores.

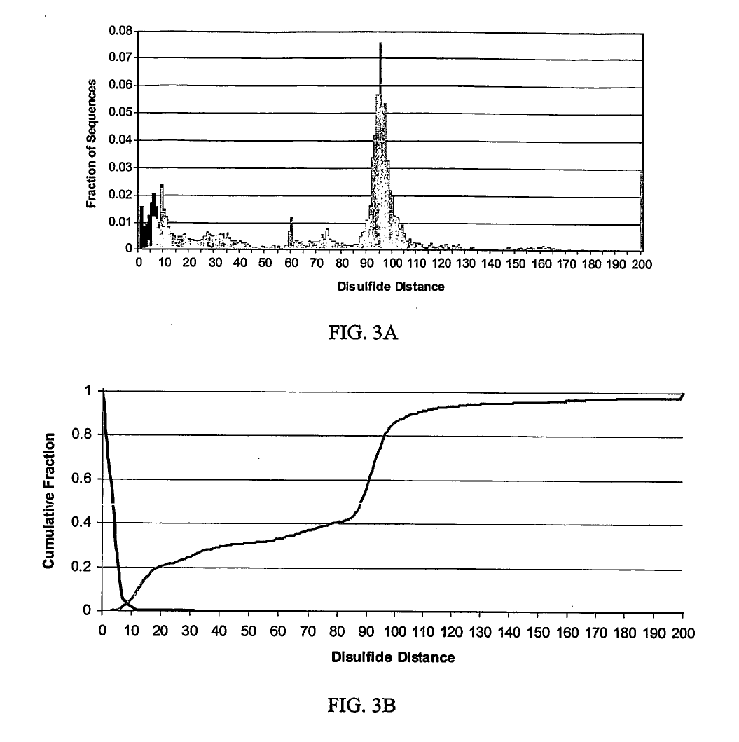

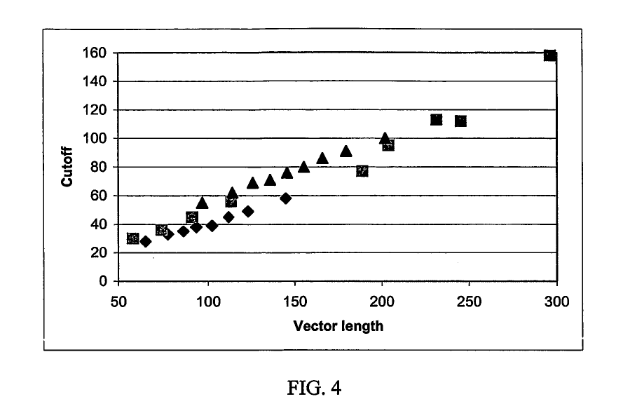

The ability of the disulfide distance dₘₙ to distinguish between related and unrelated proteins is illustrated in FIG. 3A for proteins containing three disulfide bridges. The black and gray bars correspond to related and unrelated protein pairs, respectively. Proteins are defined as related if they belong to the same Pfam domain family. To determine the statistical relevance of a given distance dₘₙ between two disulfide signatures, false positive score distributions can be calculated using randomized disulfide signatures. Cumulative distributions for the comparisons between random and related disulfide signatures correspond to the false positive and false negative values as a function of disulfide distance dₘₙ, respectively (FIG. 3B). In order to define the best distance cutoff for a disulfide database search, the sum of false positive and false negative probabilities ideally should be at a minimum. If a well-defined minimum of this sum is not found, the cumulative false positive distributions can be used to assign P-values to disulfide distances obtained in a database search. FIG. 4 shows the dependence of the distance cutoff for a P-value of 0.01 on the signature length L for proteins with 3 to 5 disulfide bridges. As the signature length increases, the cutoff value dₘₙ at P=0.01 increases linearly. The data corresponding to disulfide signatures with 3, 4, and 5 disulfide bridges are represented by diamonds, squares, and triangles, respectively.

Disulfide signatures can be classified according to similarity in a three-tiered structure. The first tier of the classification involves separating disulfide signatures by the number of disulfide bridges. The second tier of the classification separates disulfide signatures by their disulfide topologies. The third tier of the classification groups disulfide signatures based on their similarity to one another, as defined by the pairwise distance dₘₙ (Eq. 1). Disulfide signatures can be grouped in the final tier by applying the single linkage, hierarchical clustering algorithm available with MatLab (Version 6.5, Release 13; Mathworks. Inc. Waltham, Mass.) to the disulfide signatures of proteins sharing the same disulfide topology.

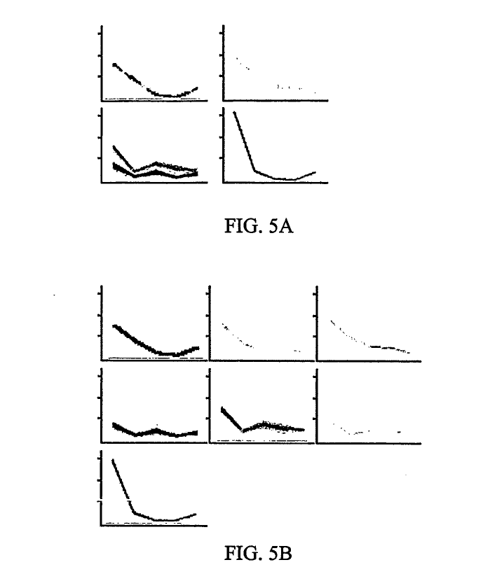

The clustering cutoffs used in generating the clusters can be individually selected for each set of sequences with the same number of disulfide bridges. Hierarchical-tree dendrograms of the disulfide signature similarities can be generated to aid in the selection of an appropriate cluster cutoff. In addition, parallel-coordinate plots of individual clusters' disulfide signatures, where each position of a disulfide signature was regarded as a coordinate, can be generated to visualize variation across the disulfide signatures. FIG. 5 shows parallel-coordinate plots of disulfide signatures with three disulfide bridges and the topology 1-6_{—}2-4_{—}3-5. In the parallel plots, each position on the horizontal axis represents one position of a disulfide signature, and the vertical axis the value of that position. The values from a single signature are connected by a straight line. In general, the more tightly grouped the lines in such a plot are, the more similar the signatures that are plotted. A more tolerant clustering cutoff of 20 is shown in FIG. 5A and a more constrained clustering cutoff of 10 is shown in FIG. 5B. With the higher cutoff, disulfide signatures belonging to different Pfam families cluster together; with the lower (more restrictive) cutoff, different Pfam families are grouped to different clusters.

Higher, more tolerant cutoffs can result in greater variation within a cluster, while smaller, more constraining cutoffs can result in less variation. The process of applying a clustering cutoff, examining the resulting clusters, and revising the cutoff value can be iteratively applied until an optimal cutoff value is attained. The point where the grouping of related disulfide signatures (those sharing the same Pfam domain) is maximized and the grouping of unrelated disulfide signatures is minimized can be considered the optimal cutoff. Once determined, the cutoff can be uniformly applied to all topologies with the same number of disulfide bridges.

The overlap between clusters can be calculated to evaluate the separation of clusters. Each cluster can have a band or range of values designated, called the disulfide signature range, for each position in the disulfide signature string. The range can be defined by the minimum and maximum values at the same position across other disulfide signatures in a cluster. Next, disulfide signatures from other clusters, sharing the same topology, can be tested for inclusion within the disulfide signature range of a given cluster. This process can be repeated for all clusters of the same number of disulfide bridges.

Visual depictions of the disulfide signature classification can be created with the graphing toolkit GraphViz (AT&T Research Labs). The classifications can be displayed in a wheel shape composed of two concentric rings of nodes connected by lines extending radially outward. The two rings correspond to the latter two tiers of the classification. Separate wheels can be constructed for each disulfide signature length. The wheels can be labeled in the center with a number indicating the length of the disulfide signatures present in the classification wheel. A node for each observed topology in a disulfide signature length is placed in the inner concentric ring. Topologies on the classification wheel can be ordered by complexity, such that less complex topologies are displayed in the first quadrant of the wheel and progressively more complex appear in a counter-clockwise fashion. Disulfide topology complexity can depend on two factors: the total number of intersections and overlaps occurring between cysteine pairs. An intersection occurs when a cysteine of one disulfide bridge (x₁, x₂) lies in between the cysteines of another disulfide bridge (a₁,a₂),
(x₁,x₂)|((a₁<x₁)ˆ(x₁<a₂))ˆ(x₂>a₂)

An overlap of disulfide bridges occur when one disulfide bridge (x₁,x₂) is completely encompassed within another disulfide bridge (a₁,a₂),
(x₁,x₂)|((a₁<x₁)ˆ(x₁<a₂))ˆ(x₂<a₂)

Every topology observed in a given classification wheel can be assigned a complexity score, defined as the sum of the number of intersections and overlaps, and ranked against other topologies sharing the same number of disulfide bridges. Topologies with the same complexity score can be delineated first by symmetry and alphanumerically. See, for example, Benham, C. J. & Jafri, M. S. Protein Sci. (1993) 2, 41-54; Kikuchi, T., et al., J. Comp. Chem. (1986) 7, 67-88; and Kikuchi, T., et al., J. Comp. Chem. (1988) 10, 287-294, each of which is incorporated by reference in its entirety. Non-symmetrical topologies can be considered more complex than symmetrical topologies. This approach does not definitively separate one topology's complexity from another; however, it effectively separates less complex topologies from more complex ones such that general trends between the two may be observed.

Links between clusters having different numbers of disulfide bridges can be constructed by forming connected graphs, which can be regarded as extended clusters. For example, links can be generated between clusters of signature length (n−1) or (n−2) and a cluster of signature length n, in which case the links correspond to the elimination of one or two disulfide bridges, respectively. The links between the clusters can be determined by first generating all subpatterns of length (n−1) and (n−2) for every disulfide signature of length n. The subpatterns can then be compared with the signatures of corresponding length in the (n−1) or (n−2) classification wheels. A disulfide topology constraint can be imposed in these comparisons, such that only patterns of equivalent topologies to the subset patterns are compared. If the similarity score calculated between a subpattern and a classified pattern is below the cutoff used in the hierarchical clustering of the respective classification wheel, a link can be drawn between the cluster from which the subpattern originated and the cluster containing the classified pattern. This technique can be recursively applied to all disulfide signatures. In the case of the disulfide signatures with three disulfides, only the (n−1) subpatterns can be generated as the disulfide classification is only applied to patterns with two or more disulfides. Discrete networks of connected clusters formed in the linking process can then be determined and information about the encompassed disulfide patterns (i.e. Pfam distribution, structural information) can be generated.

The various techniques, methods, and aspects described above can be implemented in part or in whole using computer-based systems and methods. Additionally, computer-based systems and methods can be used to augment or enhance the functionality described above, increase the speed at which the finctions can be performed, and provide additional features and aspects as a part of or in addition to those described elsewhere in this document. Various computer-based systems, methods and implementations in accordance with the above-described technology are presented below.

In one implementation, a general-purpose computer may have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client , or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs may be installed on the internal or external storage of the general-purpose computer. Alternatively, in another implementation, application programs may be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer may include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link may include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software may be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the finctions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (HTTP)). The selected page is then displayed to the user on the client's display screen. The client may then cause the server containing a computer program to launch an application to, for example, perform an analysis according to the described techniques. In another implementation, the server may download an application to be run on the client to perform an analysis according to the described techniques.

### EXAMPLES

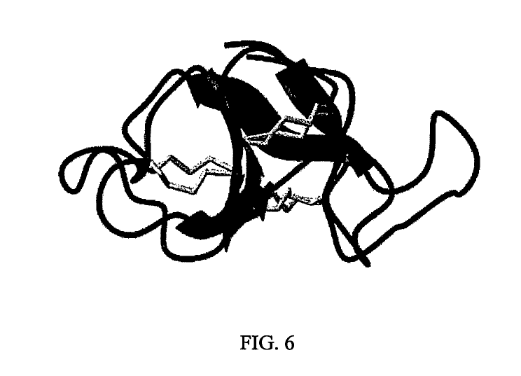

ATX Ia is a 46-residue neurotoxin of the sea anemone Anemonia sulcata that exerts its toxicity by blocking sodium channels. Its structure was solved by NMR and revealed a four-stranded β-sheet structure containing three disulfide bridges. The structural elucidation showed that ATX Ia was structurally similar to the 43-residue antihypertensive and antiviral protein BDS-I from the same species (see Widmer, H., et al., Proteins (1989) 6, 357-371; and Driscoll, P. C., et al., Biochemnistry (1989) 28, 2188-2198, each of which is incorporated by reference in its entirety). BDS-I operates by blocking potassium channels. Widmer et al., noted that the homology between the two proteins was not obvious from a comparison of amino acid sequences. Despite significant advances in sequence homology search methods and protein sequence databases, the absence of observable sequence homology remains. A PSI-BLAST search (5 iterations, E-value cutoff 0.01) of the ATX-Ia protein sequence in both the SwissProt/TrEMBL and the non-redundant NCBI NR databases did not find the BDS-I protein, and vice versa. In contrast, a disulfide-based search in the database readily finds the BDS-I protein when the ATX-Ia disulfide signature is used as the query (Table 2). The Structural Classification of Proteins (SCOP) database classifies these proteins in the same structural family (see Lo Conte, L., et al., Nucleic Acids Res. (2000) 28, 257-259, which is incorporated by reference in its entirety). The structural similarity between these proteins is illustrated in FIG. 6. A color version of FIG. 6 appears in van Vlijmen H W T, Gupta A, Narasimhan L S, Singh J. A novel database of disulfide patterns and its application to the discovery of distantly related homologs. J. Mol. Biol. 2004 Jan 23;335(4):1083-92, which is incorporated by reference in its entirety. In this case, structural homology translates directly to functional homology, since both proteins bind to and inhibit ion channels of similar structure.

Table 2 presents results for a search of a disulfide database using the disulfide signature of ATX-Ia (SwissProt code TXA1_ANESU). The columns in the table indicate the disulfide distance d, the false positive score (P-value), the Pfam domain, the SwissProt protein code, the disulfide signature, the cysteine spacing pattern, the residue numbers of the disulfides, the disulfide topology, the sequence bounds of the Pfam domain, the number of disuifides, and the available structural information. If there is a PDB structure of the hit itself a PDB code is listed. If any members of the Pfam family of the hit has a PDB structure, the PDB code is shown in brackets. Each row represents a hit, ordered from the closest hit (i.e. the shortest distance from the ATX-Ia signature) to the farthest. The first entry is the ‘self-hit’, the ATX-Ia signature, with a distance of exactly zero. A number of hits from the PF00706 family were removed to highlight the hits of interest. The BDS-I protein has the SwissProt code BDS1_ANESU.

TABLE 2

| | | | | Search | | | | | | |
|---|---|---|---|---|---|---|---|---|---|---|
| Score | P(x) | Class | Chain | pattern | CysSeq | ExpSeq | Top | Bounds | Length | Struct |
| 0.00 | 0 | PF00706 | TXA1_ANESU | 39-2-28- | 2-21-7- | 4-43-6-34- | 1-5_2- | 3-44 | 3 | 1atx |
| | | | | 21-17 | 9-1 | 27-44 | 4_3-6 | | | |
| 1.41 | 0 | PF00706 | TXA2_RADMA | 40-2-28- | 2-21-7- | 3-43-5-33- | 1-5_2- | 2-44 | 3 | [1atx, . . . ] |
| | | | | 21-18 | 10-1 | 26-44 | 4_3-6 | | | |
| 4.24 | 0 | PF00706X | CLX1_CALPA | 39-2-28- | 2-18-10- | 36-75-38-66- | 1-5_2- | 35-76 | 3 | [1atx, . . . ] |
| | | | | 18-20 | 9-1 | 56-76 | 4_3-6 | | | |
| 4.24 | 0 | PF00706X | CLX2_CALPA | 39-2-28- | 2-18-10- | 36-75-38-66- | 1-5_2- | 35-76 | 3 | [1atx, . . . ] |
| | | | | 18-20 | 9-1 | 56-76 | 4_3-6 | | | |
| 4.24 | 0 | PF00706 | TXAB_ANTXA | 42-2-30- | 2-23-7- | 4-46-6-36- | 1-5_2- | 3-47 | 3 | [1atx, . . . ] |
| | | | | 23-18 | 10-1 | 29-47 | 4_3-6 | | | |
| 4.24 | 0 | PF00706 | TXAA_ANTXA | 42-2-30- | 2-23-7- | 4-46-6-36- | 1-5_2- | 3-47 | 3 | [1atx, . . . ] |
| | | | | 23-18 | 10-1 | 29-47 | 4_3-6 | | | |
| 6.78 | 0.000413 | NULL | BDS1_ANESU | 35-2-26- | 2-16-10- | 4-39-6-32- | 1-5_2- | 0-0 | 3 | 1bds |
| | | | | 16-18 | 7-1 | 22-40 | 4_3-6 | | | |
| 10.95 | 0.001032 | PF00321 | THN_PYRPU | 38-1-27- | 1-12-11- | 3-41-4-31- | 1-6_2- | 1-47 | 3 | [1cnb, . . . ] |
| | | | | 12-11 | 4-10 | 16-27 | 5_3-4 | | | |
| 11.62 | 0.001652 | PF00321X | Q9S980 | 37-1-28- | 1-12-10- | 27-64-28-56- | 1-6_2- | 25-70 | 3 | [1cnb, . . . ] |
| | | | | 12-10 | 6-8 | 40-50 | 5_3-4 | | | |
| 13.78 | 0.002375 | PF01549X | Q9M0K1 | 40-7-26- | 7-9-17- | 275-315- | 1-6_2- | 274-315 | 3 | [1roo, . . . ] |
| | | | | 9-21 | 4-3 | 282-308- | 4_3-5 | | | |
| | | | | | | 291-312 | | | | |

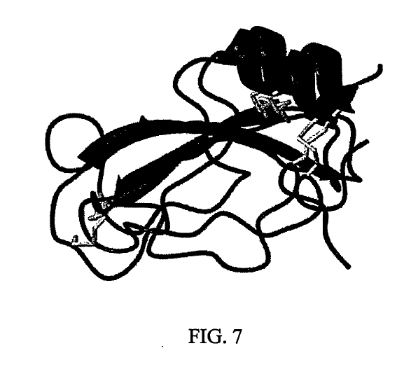

The solution structure of the 60-residue recombinant tick anticoagulant protein (rTAP) was solved by NMR and shown to be structurally similar to Kunitz-type proteinase inhibitors such as bovine pancreatic trypsin inhibitor (BPTI) (see Antuch, W., et al., FEBS Lett. (1994) 352, 251-257, which is incorporated by reference in its entirety). Both structures contain a two-stranded β-sheet and a C-terminal α-helix, stabilized by three disulfide bonds See FIG. 7. A color version of FIG. 7 appears in van Vlijmen H W T, Gupta A, Narasimhan L S, Singh J. A novel database of disulfide patterns and its application to the discovery of distantly related homologs. J. Mol. Biol. 2004 Jan. 23;335(4):1083-92, which is incorporated by reference in its entirety. TAP and BPTI are both inhibitors of proteinases: Factor Xa and trypsin, respectively. The absence of significant sequence homology between TAP and BPTI was noted by Antuch et al., and PSI-BLAST searches in the current versions of SwissProt/TrEMBL and NR were unsuccessffil in identifying the similarity between these two proteins. The disulfide-based search (using the disulfide signature of TAP as the pattern to match) readily identified the structural relationship between these proteins, as shown in Table 3. The columns in Table 3 the same as for Table 2. The SCOP database classified these proteins in the same category at the superfamily level.

TABLE 3

| | | | | Search | | | | | | |
|---|---|---|---|---|---|---|---|---|---|---|
| Score | P(x) | Class | Chain | pattern | CysSeq | ExpSeq | Top | Bounds | Length | Struct |
| 0.00 | 0 | NULL | TAP_ORNMO | 54-10-24- | 10-18-6- | 5-59-15-39- | 1-6_2- | 0-0 | 3 | 1tap |
| | | | | 18-22 | 16-4 | 33-55 | 4_3-5 | | | |
| 2.45 | 0 | PF00014 | TFP2_HUMAN | 53-10-24- | 10-16-8- | 96-149-106- | 1-6_2- | 96-149 | 3 | [5pti, . . . ] |
| | | | | 16-23 | 15-4 | 130-122-145 | 4_3-5 | | | |
| 3.74 | 0 | PF00014 | ISC2_BOMMO | 51-10-24- | 10-16-8- | 9-60-19-43- | 1-6_2- | 9-60 | 3 | [5pti, . . . ] |
| | | | | 16-21 | 13-4 | 35-56 | 4_3-5 | | | |
| 4.69 | 0 | PF00014 | TFPI_RAT | 50-9-24- | 9-16-8- | 124-174-133- | 1-6_2- | 124-174 | 3 | [5pti, . . . ] |
| | | | | 16-21 | 13-4 | 157-149-170 | 4_3-5 | | | |
| 4.69 | 0 | PF00014 | SPT2_HUMAN | 50-9-24- | 9-16-8- | 133-183-142- | 1-6_2- | 133-183 | 3 | [5pti, . . . ] |
| | | | | 16-21 | 13-4 | 166-158-179 | 4_3-5 | | | |
| 4.69 | 0 | PF00014 | A4_HUMAN | 50-9-24- | 9-16-8- | 291-341-300- | 1-6_2- | 291-341 | 3 | 1aap |
| | | | | 16-21 | 13-4 | 324-316-337 | 4_3-5 | | | |
| 4.69 | 0 | PF00014 | IVB3_VIPAA | 50-9-24- | 9-16-8- | 7-57-16-40- | 1-6_2- | 7-57 | 3 | [5pti, . . . ] |
| | | | | 16-21 | 13-4 | 32-53 | 4_3-5 | | | |
| 4.69 | 0 | PF00014 | BPT2_BOVIN | 50-9-24- | 9-16-8- | 40-90-49-73- | 1-6_2- | 40-90 | 3 | [5pti, . . . ] |
| | | | | 16-21 | 13-4 | 65-86 | 4_3-5 | | | |
| 4.69 | 0 | PF00014 | BPT1_BOVIN | 50-9-24- | 9-16-8- | 40-90-49-73- | 1-6_2- | 40-90 | 3 | 5pti |
| | | | | 16-21 | 13-4 | 65-86 | 4_3-5 | | | |
| 4.69 | 0 | PF00014 | CA36_HUMAN | 50-9-24- | 9-16-8- | 3111-3161- | 1-6_2- | 3111-3161 | 3 | 1knt |
| | | | | 16-21 | 13-4 | 3120-3144- | 4_3-5 | | | |
| | | | | | | 3136-3157 | | | | |

In a recent study of the CFC domain of human Cripto, a disulfide database search tool was employed to obtain structural information on the protein. See van Vlijmen, H. W. T., et al., Eur. J. Biochem (2003) 270(17), 3610-3618, which is incorporated by reference in its entirety. Cripto is a protein involved in early embryonic development and was shown to be overexpressed in a number of human cancers (see Saloman, D. S., et al., Endocr. Relat. Cancer (2000) 7, 199-226, which is incorporated by reference in its entirety). Cripto family proteins are characterized by two cysteine-rich structural motifs: an epidermal growth factor (EGF)-like domain and a CFC domain, the latter of which is considered unique to this family. The experimentally determined disulfide pattern of the CFC domain, which contains three disulfide bridges, was used as a search template to look for related proteins of known structure in the disulfide database. The search revealed two small, structurally related serine protease inhibitors, PMP-D2 and PMP-C. Both proteins are classified as VWFC (von Willebrand Factor C)-like domains. BLAST searches with the CFC domain sequence on SwissProt/TrEMBL and NCBI NR databases do find the VWFC domains, albeit with very low confidence (E-values>1).

The annotation of the CFC domain as a VWFC domain resulted in the identification of a number of proteins that have the same modular structure of an EGF-like domain followed by a VWFC domain, including NELL1, NELL2, JAGGED1, and JAGGED2. This inferred structural relationship also suggested functional similarities among the proteins. A comparison between Cripto and JAGGED2 showed that they have distinct similarities at the sequence level (undetectable by sequence search algorithms), that they are both involved in signal transduction, and that both play roles in patterning and morphogenesis in early embryonic development.

The NMR structure of PMP-C (PDB code Ipmc) was used to build a three-dimensional model of the Cripto CFC domain. The model was consistent with data from functional studies on mutants of the CPC domain, since two very important residues for interaction of the CFC domain with the Alk4 receptor, H120 and W123, were both located in the same area on the solvent accessible surface of the structural model.

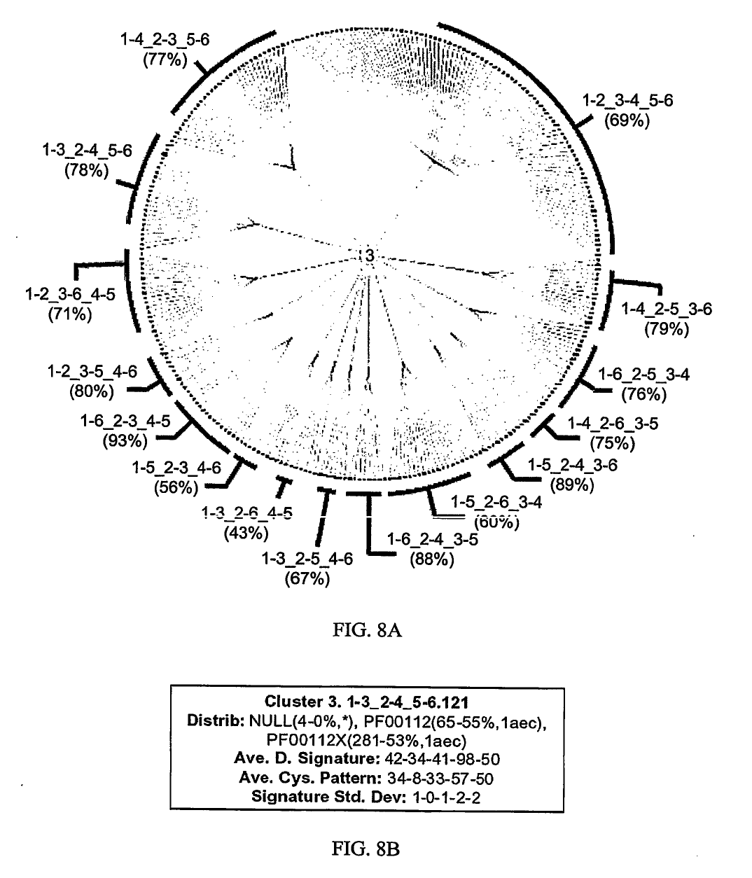

The clusters of similar disulfide signatures generated from the clustering process can be represented as rectangles placed on the outer ring of the classification wheel. Each cluster can be annotated with a cluster identifier and details about the contents of the cluster (FIG. 8B). The cluster identifier can include, for example, the number of the disulfide bridges represented, the disulfide topology under which the cluster belongs, and a cluster number. For example, the values for these three descriptors can be separated by periods and concatenated together to form the cluster identifier string. For example, in the cluster identifier 3.1-3_{—}2-4_{—}5-6.121, the ‘3’ indicates that each of the disulfide signatures contained in the cluster has three disulfides, and the ‘1-3_{—}2-4_{—}5-6’ reveals the topology of the signatures present in the cluster. The last part of the cluster identifier, ‘121’, is the cluster's assigned number within the three-disulfide classification wheel. The annotation can also include the distribution of Pfam domains represented in the cluster as well as the consensus disulfide signatures computed for the cluster. The consensus disulfide signatures, defined by the average for each position of the disulfide signature strings contained within a cluster, can be calculated for both disulfide signatures and cysteine spacing patterns. The annotation can include references to available structural information, such as entries in the PDB or Homology-derived Secondary Structures of Proteins (HSSP) (see Sander, C. & Schneider, R. Proteins (1991) 9, 56-68, which is incorporated by reference in its entirety). These references can be obtained from either SwissProt or Pfam structural annotations.

The classification wheel for sequences with three disulfides is shown in FIG. 8A. The number three in the center of the wheel signifies the first level of the disulfide classification, that only disulfide signatures with three disulfide bridges are displayed in the wheel. Each ellipse in the inner ring represents a different topology. All 15 of the possible topologies for disulfide signatures with three disulfide bridges are observed, so 15 ellipses are present in the inner ring.

Within a single topology, a large range of structures and functions can be observed. For instance, the topology 1-2_{—}3-4_{—}5-6 contains families of proteins as diverse as eukaryotic aspartyl proteases and hemagglutinins. These families share no common structural or finctional qualities, yet are classified together at the topology level because they share the same disulfide topology. The third tier of the disulfide classification enables protein domains with similar structures and functions to be classified together. Classifications based solely on disulfide topology (i.e. classifications including only the first and second tiers) perform poorly at uniting related protein domains. The third tier of the classification has not been previously reported in disulfide classification approaches.

All 287 clusters in the three-disulfide classification wheel were assigned cluster identifiers and annotated. Reviewing the annotations reveals that 209 of the 287 clusters (73%) contain disulfide signatures from at least one Pfam domain associated with three dimensional structural information (FIG. 8A). The fraction of clusters with structural information ranges across the topologies. For example, the topology 1-6_{—}2-3_{—}4-5 has structural information for 93% of its clusters, whereas topology 1-3_{—}2-6_{—}4-5 has structural information for 43% of its clusters.

The number of clusters per topology is not uniformly distributed across the different topologies. Since similar disulfide signatures are grouped together into a cluster, each cluster can be thought of as a distinct disulfide signature. The disulfide classification wheel reveals a greater diversity of disulfide signatures within a particular topology by the increased number of clusters extending from that topology. Moreover, the radial arrangement of the classification depiction can reveal any trends in the diversity of disulfide signature that may occur across the different topologies. The first three simplest topologies exhibit the greatest diversity in disulfide signatures: 1-2_{—}3-4_{—}5-6 encompasses 31% of the clusters, 1-4_{—}2-3_{—}5-6 encompasses 11% of the clusters, and 1-3_{—}2-4_{—}5-6 encompasses 8% of the clusters. These three topologies make up half of the clusters in the three-disulfide classification wheel.

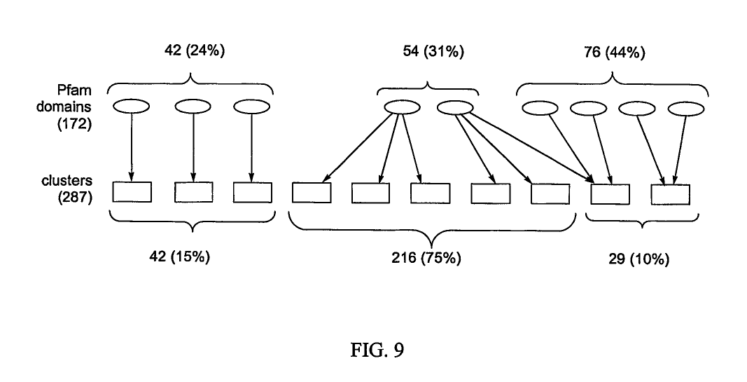

FIG. 9 describes the distribution of clusters in the three-disulfide wheel among Pfam domains. For 118 (42 plus 76) of the 172 Pfam domains (69%) represented in the three-disulfide classification wheel, all of the disulfide signatures belonging to a domain were found grouped together into a single cluster of the classification wheel. Although multiple Pfam domains can be found in a single cluster, the grouping of related disulfide signatures into a single cluster indicates that the disulfide topologies and cysteine spacings are highly conserved within these domains. In the remaining 54 domains (31%), however, disulfide signatures split across multiple clusters and even multiple topologies. This situation of related disulfide signatures having different topologies can occur when a novel disulfide bridge incorporates itself into the fold of the protein, displaces another disulfide bridge present in the fold, and changes the overall disulfide connectivity of the protein domain. From a cluster perspective, 258 (216 plus 42) out of 287 clusters (90%) contain only a single Pfam domain. This suggests that most disulfide signatures are associated with a unique structure and function. Interestingly, the clusters with disulfide signatures from multiple Pfam domains arise due to significant similarities in the disulfide signatures.

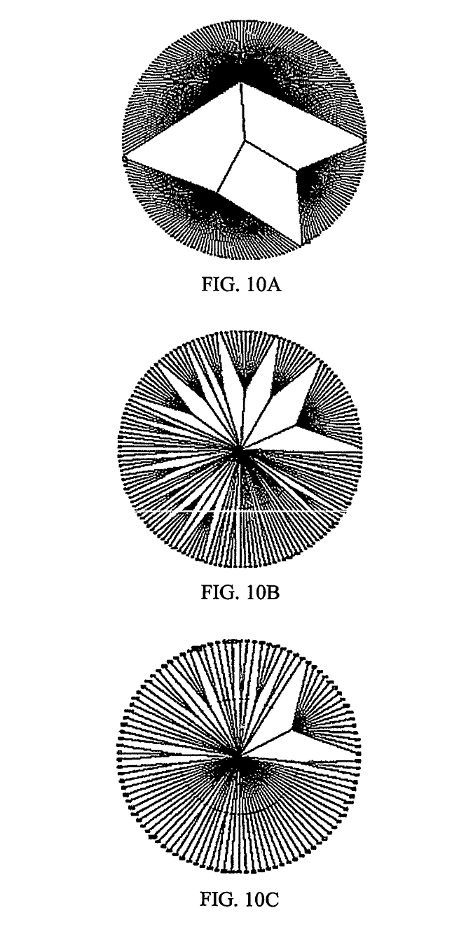

FIGS. 10A, 10B and 10C show the classification wheels for disulfide signatures of two, four, and five disulfide bridges, respectively. Although a smaller number of signatures are present in the two-, four-, and five-disulfide classification wheels, many important comparisons can be made with the three-disulfide classification wheel. Across the wheels, the disulfide signature diversity is greatest in the less complex topologies. The first few least complex topologies contain the greatest number of clusters in the wheels. Also, the fraction of disulfide signatures with references to structural information for the two- and the four- through eight disulfide classification wheels ranges from 44%-56% and is similar to that of the three disulfide classification wheel.

For domains with four disulfide bridges, 59 of the 105 (59%) possible disulfide topologies were represented in the database. In domains with five disulfide bridges, only 66 of the 945 (7%) possible topologies were observed. For topologies with greater than five disulfide bridges, less than 1% of the total theoretical topologies were observed. It should be noted, however, that the number of theoretical disulfide topologies increases exponentially with the number of disulfide bridges. Some of these observations have been made while exploring the topological properties of disulfide bonding patterns (Benham, C. J. & Jafri, M. S. Protein Sci. (1993) 2, 41-54). However, a significant number of topologies were present in the database that were not previously noted. These new topologies were only found in topologies of more than three disulfide bridges (Table 4), as all of the possible topologies for domains with one, two, or three disulfide bridges were already observed. Interestingly, a few of the topologies recorded previously were not found in our database. We suspect that these missing topologies are attributed to the disulfide annotations of multi-domain proteins, since the earlier analysis considered entire protein sequences rather than independent structural domains.

Multiple cases of proteins with nonplanar disulfide topologies (Benham, C. J. & Jafri, M. S. Protein Sci. (1993) 2, 41-54), were identified in the database. Numerous proteins from the RTI/MTI-2 protease inhibitor, gamma thionin, transferrin, and long-chain scorpion toxin families exhibit nonplanar topologies. Moreover, a second, nonplanar disulfide topology 1-4_{—}2-3_{—}5-12_{—}6-9_{—}7-10_{—}8-11_{—}13-14 that had not been previously recorded was present in the database.

A detailed analysis of the cutoffs used in the clustering process was conducted to optimize the grouping of similar disulfide signatures. Parallel plots of disulfide signatures were generated to validate the clustering cutoffs. FIG. 5 shows disulfide signature parallel-plots for the clusters with three disulfide bridges and the topology 1-6_{—}2-4_{—}3-5. When a more tolerant clustering cutoff was applied, there was significant variation in the disulfide signatures and multiple unrelated Pfam domains cluster together (FIG. 5A). In FIG. 5B, the clustering cutoff was reduced by half and less variation across the disulfide signature coordinates was observed. Moreover, the disulfide signatures separate such that only related sequences were found grouped together into the same cluster. Upon optimization of the clustering cutoffs for each wheel, similar, less varying clusters were created across all of the classification wheels. The clustering cutoff values selected for the different classification wheels are shown in Table 4.

TABLE 4

| # | # of | Clustering | # of | Topologies | Previously | | |
|---|---|---|---|---|---|---|---|
| of disulfides | patterns | cutoff | clusters | observed | reported | New | Missing |
| 2 | 13,188 | 8 | 292 | 3 | 3 | 0 | 0 |
| 3 | 17,940 | 10 | 287 | 15 | 15 | 0 | 0 |
| 4 | 3,667 | 15 | 154 | 59 | 15 | 44 | 1 |
| 5 | 1,662 | 25 | 102 | 66 | 9 | 57 | 6 |
| 6 | 837 | 45 | 58 | 47 | 4 | 43 | 5 |
| 7 | 1,038 | 50 | 36 | 32 | 3 | 29 | 2 |
| 8 | 629 | 50 | 29 | 25 | 1 | 24 | 2 |
| 9 | 1,625 | 50 | 18 | 14 | 0 | 14 | 1 |
| 10 | 34 | 50 | 14 | 13 | 0 | 13 | 0 |

The overlap between clusters was calculated using the described techniques in order to assess how well the clusters were separated. Each cluster was assigned a disulfide signature range, defined by the minimum and maximum values observed for each position of the disulfide signatures encompassed within the clusters. For the two-disulfide classification wheel, approximately 6% of the disulfide signatures in the wheel fit into the disulfide signature ranges of more than one cluster in the wheel. This non-trivial overlap was not observed, however, in the other classification wheels. Although several of the disulfide signature ranges overlapped slightly in the three- through ten-disulfide bridge classification wheels, only one example of a disulfide signature fitting within the disulfide signature ranges of two different clusters was observed. No other overlaps were found in the four- through ten-disulfide classification wheels. This indicates that the clusters are well-separated for disulfide signatures with three or more disulfide bridges. Moreover, this indicates that the classification of a given disulfide signature with greater than two disulfides can be unambiguous.

In cases where multiple Pfam domains were grouped together into the same cluster, Structural Classification of Proteins (SCOP), Revision 1.61 was consulted to assess the validity of the classification based on structural arguments (see Murzin, A. G., et al., J. Mol. Biol. (1995) 247, 536-540, which is incorporated by reference in its entirety). For each of the clusters with multiple Pfam domains in the three-, four-, and five-disulfide classification wheels, all of the possible pairwise comparisons were made between the Pfam domains in a given cluster to identify the greatest level of structural similarity designated in SCOP (Table 5). The measure of similarity was limited to the first four levels of increasing similarity in SCOP: class, fold, superfamily, and family. Pairwise comparisons were not made for Pfam domains lacking structural information. 339 (40%) of the possible 838 pairwise comparisons were performed. Pfam domains which grouped together in the four- or five-disulfide classification wheels generally exhibited high structural similarity. Across the three-, four-, and five-disulfide classification wheels, more than half of the pairwise comparisons performed reflected structural similarities on at least the fold level. About 19% of the pairwise comparisons indicated structural similarities on the family or superfamily level, which strongly suggests common evolutionary origins. The pairwise comparisons reflecting structural similarities on the fold level highlight the ability of the disulfide classification to group together structurally related proteins that would be otherwise difficult to relate without knowledge of their three-dimensional structures.

Domains present in clusters that included multiple Pfam domains and “NULL” domains were carefully examined for homologous structures or functions. In several cases, similarities between related proteins could not be found through sequence comparison means because no significant sequence similarity was present. The homologies in these cases have been determined only through analyses of three-dimensional structures. Interestingly, these structural relationships could have been made solely through comparisons of their respective disulfide signatures. A complete listing of the clusters containing multiple domains is shown in Table 5. For each cluster, a range of percent sequence identities across the domains present in the cluster is included in Table 5. These identities were calculated by first aligning the disulfide-containing sequence domains of different domain families using the Needleman-Wunsch algorithm (see Needleman, S. B. & Wunsch, C. D. J. Mol. Biol. (1970) 48, 443-453, which is incorporated by reference in its entirety). For clusters with more than 500 disulfide signatures (indicated in Table 5 with an asterisk), 15 sequences were randomly selected from each domain to be used in the sequence identity range calculation. Table 5 shows a listing of clusters containing multiple Pfam domains from the three-, four-, and five-disulfide classification wheels. A structural analysis of the clusters using SCOP is also included. The columns headed cl, cf, sf, fa indicate the first four levels of structural homology in SCOP: class, fold, superfamily, and family.

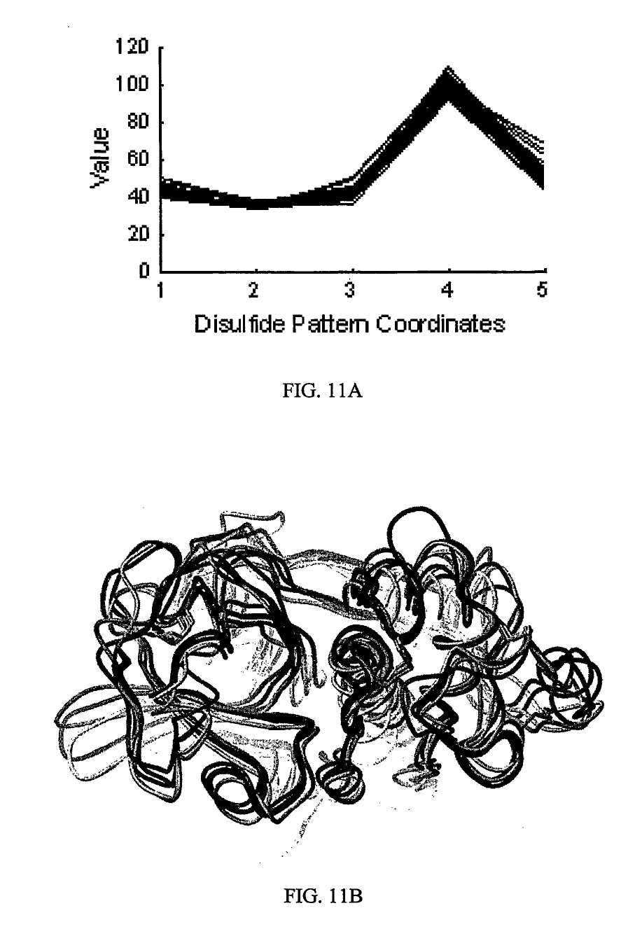

The majority of Pfam domains (69%) represented in the three-disulfide classification wheel appear in a single cluster per domain basis. One of these families, the papain family cysteine proteases (PF00112), appeared in cluster 121 of the three-disulfide classification wheel. The parallel plot of the disulfide signatures for this family (FIG. 11A) illustrates the high degree of similarity among the related disulfide signatures. A color version of FIG. 11 appears in Gupta A, Van Vlijmen H W T, Singh J. A classification of disulfide patterns and its relationship to protein structure and function. Protein Sci. 2004 August;13(8):2045-58, which is incorporated by reference in its entirety. Of the 350 disulfide signatures grouped together in the cluster, 79% are inferred disulfide signatures generated from the inferring algorithms as described above, as indicated by the “PF00112X” family annotation in FIG. 8A. The remaining disulfide signatures were extracted directly from SwissProt. The disulfide signatures with defined domain boundaries in Pfam are annotated with the “PF00112” class assignment, and the signatures without defined boundaries are annotated with “NULL” class assignment. The SwissProt functional annotations for the “NULL” disulfide signatures indicate that the proteins are indeed related to the other sequence domains of the PF00112 family. A superposition of five representative three-dimensional structures associated with the signatures in this cluster is shown in FIG. 11B. The low average RMSD (1.32 Å±0.30 Å for Cα atoms) of the superposition reflects the strong structural conservation across Six domain families clustered together in cluster 83 of the five-disulfide classification wheel (Table 5). This situation of multiple Pfam domains grouping together into the same cluster occurred in less than 10% of the clusters of the three- through ten-disulfide classification wheels. In this cluster, a few disulfide signatures were assigned to belong to “NULL” domain, and therefore correspond to sequence segments not present in Pfam. Two Pfam-B domains, PB004042 and PB073771, appeared in the cluster and are annotated in Pfam as related to the Pfam-A u-PAR/Ly-6 domain (PF00021), which also appeared in the cluster. This situation of related sequences not coupled with their Pfam-A domain counterparts arose when sequences in the automatically generated Pfam-B alignments have not yet been manually reviewed and appended to their corresponding Pfam-A domains. The disulfide signatures from these Pfam-B domains mostly belong to sperm acrosomal proteins. Although no structural information exists for these proteins, the functional annotations indicate the presence of Ly-6 domains within the sequences. Moreover, the SwissProt entries corresponding to these proteins do not contain any disulfide annotations: the disulfide signatures utilized in the clustering were inferred. The inclusion of these sequences into the cluster highlights the capacity of the inferred disulfide annotations to encompass a much greater disulfide space than is explicitly annotated in SwissProt.

TABLE 5

| | | | Domain | | | | | |
|---|---|---|---|---|---|---|---|---|
| | | % sequence | pairs w/ | SCOP similarity | | | | |
| Cluster # | Domains present | identity | PDBs | None | cl | cf | sf | fa |

5-Disulfide classification wheel

| | | | | | | | | |
|---|---|---|---|---|---|---|---|---|
| 25 | PB000034, PB004006, PB017918 | 14.5%-23.1% | 0 | — | — | — | — | — |
| 83 | PB004042, PB073771, PF00021, | 9.8%-54.5% | 1 | — | — | — | — | 100 |
| | PF00087, PF01064 | | | | | | | |

4-Disulfide classification wheel

| | | | | | | | | |
|---|---|---|---|---|---|---|---|---|
| 9 | PF00219, PF01033 | 14.8%-29.5% | 1 | 100 | — | — | — | — |
| 59 | PF00021, PF00053, PF00087, PF01064 | 10.3%-29.4%* | 1 | — | 100 | — | — | — |
| 100 | PB013405, PB036929, PF02819, | 11.4%-63.9% | 3 | — | — | 67 | — | 33 |
| | PF05309 | | | | | | | |
| 101 | PF00537, PF05353 | 19.0%-23.8% | 1 | — | — | 100 | — | — |
| 149 | PB008170, PF00304, PF00537 | 6.5%-33.3% | 1 | — | — | — | 100 | — |

3-Disulfide classification wheel

| | | | | | | | | |
|---|---|---|---|---|---|---|---|---|
| 3 | PB000034, PB008407, PB017282, | 4.5%-32.4% | 3 | — | — | — | 100 | — |
| | PF00053, PF00086, PF01033 | | | | | | | |
| 10 | PB000034, PB007041 | 21.8%-23.3% | 0 | — | — | — | — | — |
| 90 | PB000320, PB058864, PB071582, | 7.9%-31.0% | 6 | 17 | 67 | 17 | — | — |
| | PF00020, PF00246, PF00429, PF00713 | | | | | | | |
| 105 | PB074800, PF00020 | 55.2%-58.6% | 1 | — | — | — | — | 100 |
| 123 | PF00008, PF00053, PF00187, PF00219, | 6.2%-68.1%* | 91 | 19 | 42 | — | 7 | 33 |
| | PF00757, PF01826 | | | | | | | |
| 146 | PB024067, PB055043, PF00057 | 12.1%-43.9%* | 33 | 33 | — | 33 | — | 33 |
| 148 | PF05337, PF02947 | 17.6%-21.9% | 1 | — | — | — | — | 100 |
| 152 | PF00087, PF00184 | 25.0%-26.6% | 0 | — | — | — | — | — |
| 188 | PB01046, PB011477, PB014575, | 2.6%-92.6% | 210 | 18 | 9 | 59 | 7 | 7 |
| | PB016009, PB022013, PB023815, | | | | | | | |
| | PB038421, PB038777, PB047402, | | | | | | | |
| | PB053988, PB054370, PB074066, | | | | | | | |
| | PB074072, PB074098, PF00187, | | | | | | | |
| | PF00299, PF00304, PF00451, PF00537, | | | | | | | |
| | PF01097, PF01821, PF02048, PF02822, | | | | | | | |
| | PF02950, PF02977, PF03488, PF03784, | | | | | | | |
| | PF05196, PF05374 | | | | | | | |
| 194 | PF00019, PF00341 | 9.7%-29.4% | 1 | — | — | — | 100 | — |
| 199 | PB018619, PF00074 | 12.6%-24.1% | 1 | 100 | — | — | — | — |
| 203 | PB012724, PB024890, PF00200, | 9.5%-30.2% | 3 | 67 | 33 | — | — | — |
| | PF05375 | | | | | | | |
| 219 | PB014575, PB037861, PB045373, | 4.8%-40.5%* | 6 | — | 83 | — | — | 17 |
| | PF00050, PF00088, PF00323, PF00711, | | | | | | | |
| | PF00819, PF01147, PF04736 | | | | | | | |
| 229 | PB002338, PB047330 | 12.2%-12.2% | 1 | — | — | — | — | 100 |
| 263 | PF00323, PF01549, PF03913 | 6.8%-38.9% | 3 | — | 100 | — | — | — |
| 274 | PB027670, PF00321 | 15.9%-15.9% | 0 | — | — | — | — | — |
| 280 | PF00024, PF01421 | 14.1%-22.8% | 1 | 100 | — | — | — | — |

A second Pfam-A domain, the snake toxin family (PF00087), and a third Pfam-A in, Activin Receptor Type I & II extracellular domain (PF01064), are also grouped into luster. The structural and functional relationship between snake toxin and u-PAR/Ly-6 in families has been previously documented, despite the absence of any significant nce similarity (see Palfree, R. G. Tissue Antigens (1996) 48, 71-79, which is incorporated by reference in its entirety). Likewise, the Activin receptor family also lacks any significant sequence similarity with the other Pfam-A domain families in this cluster. PSI-BLAST searches performed with a cutoff (E-value<0.01) on the NR database were unsuccessful in reporting similarities between the three Pfam-A families when sequences from the Activin or snake toxin families were selected as the query sequences. However, PSI-BLAST searches performed using sequences from the u-PAR/Ly-6 domains were able to find related sequences from the Activin and snake toxin families.

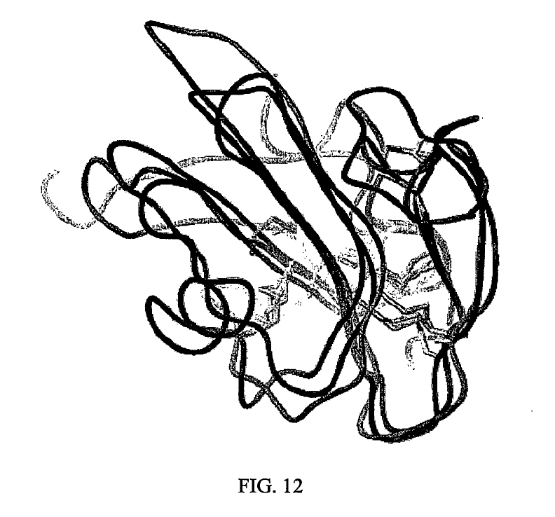

Both the Activin receptor domain family and the u-PAR/Ly-6 domain family are extracellular domains of cell surface receptors. SCOP classifies the Activin Type II Receptors and u-PAR/Ly-6 domains together on the family level, implying that an evolutionary relationship exists between the two. Furthermore, superposition using Combinatorial Extension (see Shindyalov, I. N. & Bourne, P. E. Protein Eng. (1998) 11, 739-747, which is incorporated by reference in its entirety) of representative structures from each domain family resulted in RMSD values ranging from 2.3 Å to 6.6 Å (Z-Scores ranging from 3.1 to 3.3) (FIG. 12). A color version of FIG. 12 appears in Gupta A, Van Vlijmen H W T, Singh J. A classification of disulfide patterns and its relationship to protein structure and function. Protein Sci. 2004 August;13(8):2045-58, which is incorporated by reference in its entirety. This cluster highlights the effectiveness of the disulfide classification in grouping together domain families with clear structural and finctional homologies, despite the absence of significant sequence similarity. FIG. 12 shows a superposition of representative PDB structures from the snake toxin (1cdq), u-PAR/Ly-6 domain (1f94), and Activin Receptor Type I & II Extracellular Domains (1bte). Compared to the two other structures, lbte lacks the disulfide shown in the upper right part of the structure, and has an additional disulfide, at the upper left.

Disulfide signatures from the TGF-β like domain family and the Platelet-derived Growth Factor family appeared together in cluster 194 of the three-disulfide classification wheel (Table 5). The sequences of these domains exhibit very low sequence similarity to one another (˜11%), yet a structural and fimctional homology between these two protein families exists (see Murray-Rust, J., et al., Structure (1993) 1, 153-159, which is incorporated by reference in its entirety). This relationship was discovered only after three-dimensional structures from both protein families were determined. Combinatorial Extension applied to representative PDB structures from both families (1tfg and 1pdg, respectively) yields an RMSD of 4.0 Å (Cα only) and a Z-Score of 3.3. Both families are classified together at the SCOP superfamily level, which suggests a probable evolutionary relationship. The disulfide classification effectively grouped together distantly related proteins using only disulfide spacing and cysteine connectivity information.

A large number of Pfam-A domains and automatically generated Pfam-B domains were grouped together in cluster 188 of the three-disulfide classification wheel (Table 5). The proteins grouped in the cluster displayed a considerable diversity of finctions. Only one other cluster, present in the four-disulfide classification wheel, exhibited as much diversity of protein functions as this cluster. Some of the protein families represented in the cluster, such as the scorpion toxins, omega-toxins, mu-conotoxins, plant lectins, and defensins, have long been known to have structural and finctional relationships. Other domain families present in the cluster, such as the proteinase inhibitors, cyclotides, antistatins, and conotoxins, do not have any homologous relationships with one another. Sequence similarity between proteins of the related domains was typically low, ranging from 8%-33%. PSI-BLAST searches performed with an E value cutoff of 0.01 were unable to report relationships between the related protein families in almost all of the cases.

A prominent feature of the disulfide signatures in this cluster was the relatively short length of the protein domains (average 40 residues). The disulfide signatures in the cluster therefore reflected closely-spaced cysteines with little freedom to vary across the different domain families. This cluster revealed that a small fraction of unrelated sequences are inevitably clustered together due to their short sequences and limited variability in cysteine spacing.

Disulfide signatures from the same Pfam domain family often varied in the number of disulfides. The relative loss or gain of disulfide bridges across all of the sequences within a domain family for all Pfam domains appearing in the database was tabulated. The most represented number of disulfide bridges per sequence within a family was designated as the reference number of disulfide bridges for that family. The change in the number of disulfide bridges for signatures in a family was calculated relative to the reference number of disulfide bridges for that family. Across all of the Pfam domains represented in the disulfide database, approximately 10% of the disulfide signatures per family lost or gained one disulfide bridge when compared to the reference value. The frequency of signatures losing or gaining two disulfide bridges was approximately 2%, and the frequency for shifts of three or more disulfide bridges was less than 1%. Numerous examples of disulfide signatures both losing one disulfide bridge and gaining another were also observed in the database. These exchanges of disulfide bridges, a net change of zero disulfide bridges for the domain, often accompanied changes in the overall disulfide topology of the domain as well. In this type of situations, it may be difficult to recognize similarities between signatures using the disulfide signature similarity measure (Eq. 1); however, by comparing the appropriate subsets of these disulfide signatures, relationships between signatures can often be revealed.

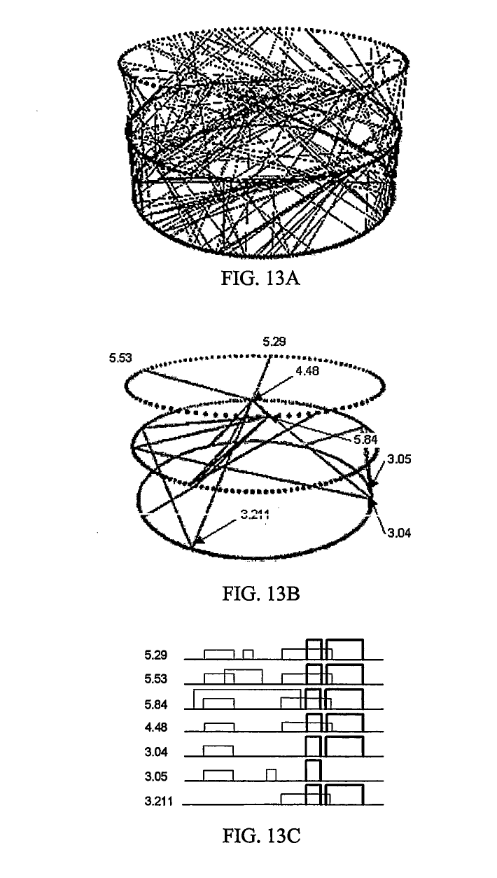

Links were formed between clusters of different classification wheels. The links formed between the three-, four-, and five-disulfide classification wheels are illustrated in FIG. 13A. A color version of FIG. 13 appears in Gupta A, Van Vlijmen H W T, Singh J. A classification of disulfide patterns and its relationship to protein structure and function. Protein Sci. 2004 August;13(8):2045-58, which is incorporated by reference in its entirety. These connected graphs or extended clusters were generated to accommodate for differences in the number of disulfide bridges across related disulfide signatures. The trypsin family domain (PF00089), for example exhibited significant diversity in its disulfide signatures. Table 6 shows two trypsin family sequences illustrating related sequences with numbers of disulfide bridges. The SwissProt sequence CFAD_HUMAN contains a trypsin domain with the disulfide signature 16-97-66-31-16-25-25. Similarly, the sequence CATG_HUMAN contains a trypsin domain with the disulfide signature 16-93-65-30-14.

TABLE 6

| SwissProt sequence | Number of disulfides | Disulfide signature |
|---|---|---|
| CFAD_HUMAN | 4 | 16-97-66-31-16-25-25 |
| CATG_HUMAN | 3 | 16-93-65-30-14 |

The subpattern of CFAD_HUMAN representing the first three disulfides (i.e. 16-97-66-31-16) is highly similar to the CATG_HUMAN disulfide pattern (dₘₙ=4.69). Since the similarity score between the two signatures is less than the clustering cutoff of 10 used in the three-disulfide classification wheel (see Table 4), the clusters containing both of these sequences are linked together by our linking algorithm. Links to the CFAD_HUMAN disulfide signature were also found when the first, second, or third disulfide bridge was removed.

Disulfide signatures from other trypsin family members were distributed among eight clusters in the three-disulfide classification wheel, seven clusters in the four-disulfide classification wheel, and four clusters in the five-disulfide classification wheel. Within a classification wheel, clusters were also found to occur across different topologies. The subgraph searching algorithms were applied to isolate the networks of connected clusters containing trypsin family members. Of the 38 separate networks of connected clusters present across the three-, four-, and five-disulfide classification wheels, the subgraph search tool found only one network that contained trypsin family members. Moreover, this single network did not encompass any other Pfam domains and successfully united 18 of the 19 trypsin family clusters (357 of 367 trypsin family disulfide signatures) across the different classification wheels. The cluster links associated with this subgraph are shown in FIG. 13B. FIG. 13C illustrates representative disulfide signatures for a small subset of the clusters. The latter two disulfide bridges, indicated with a thick line, are highly conserved across these clusters. The disulfide signatures for cluster 3.1_{—}2-3_{—}4-5_{—}6.5 (shown as ‘3.05’) is the only signature lacking one of the latter two disulfide bridges. This cluster is the only one that contains trypsin family members, but was not linked together into the trypsin subgraph. The variation observed in this family illustrates the importance of exploring disulfide signatures with different numbers of disulfide bridges when searching for related proteins.

A number of embodiments have been described. Nevertheless, it will be understood that various modifications may be made. Accordingly, other embodiments are within the scope of the following claims.

What is claimed is:

1. A method of detecting similarity between protein sequences comprising comparing a first disulfide signature to a second disulfide signature, each disulfide signature being characteristic of a corresponding protein sequence.

2. The method of claim 1, wherein each disulfide signature describes a disulfide topology of the corresponding protein sequence.

3. The method of claim 1, wherein each disulfide signature includes the number of residues between a pair of cysteines joined by a disulfide bridge, and the number of residues between the first cysteine of each disulfide bridge and the first cysteine of the next disulfide bridge in the corresponding protein sequence.

4. The method of claim 3, wherein each disulfide signature includes the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

5. The method of claim 1, wherein comparing includes calculating a measure of similarity between the first disulfide signature and the second disulfide signature.

6. The method of claim 5, wherein comparing further includes calculating a measure of statistical relevance for the measure of similarity between the first disulfide signature and the second disulfide signature.

7. The method of claim 1, wherein comparing includes searching a database including a plurality of disulfide signatures, each disulfide signature of the database characteristic of a corresponding protein sequence.

8. The method of claim 7, wherein comparing includes calculating a measure of similarity between the first disulfide signature and each of a plurality of disulfide signatures ofthe database.

9. The method of claim 7, wherein searching the database includes searching with a subpattern of the first disulfide signature.

10. The method of claim 9, wherein the subpattern is generated by calculating the disulfide signature that results when one or more disulfide bridges is removed from the protein sequence corresponding to the first disulfide signature.

11. The method of claim 7, wherein at least one disulfide signature in the database is associated with a sequence identifier.

12. The method of claim 7, wherein at least one disulfide signature in the database is associated with a domain identifier.

13. The method of claim 7, further comprising clustering disulfide signatures of the database.

14. The method of claim 13, wherein clustering includes grouping disulfide signatures by number of disulfide bridges.

15. The method of claim 13, wherein clustering includes grouping disulfide signatures by disulfide topology.

16. The method of claim 13, wherein clustering includes calculating a measure of similarity between disulfide signatures and grouping based on the measure of similarity.

17. A method of detecting similarity between protein sequences comprising:
generating a database including a plurality of disulfide signatures, each disulfide signature being characteristic of a corresponding protein sequence; and
comparing a first disulfide signature corresponding to a protein sequence to at least one disulfide signature of the database.

18. The method of claim 17, wherein each disulfide signature describes a disulfide topology of the corresponding protein sequence.

19. The method of claim 18, wherein each disulfide signature includes the number of residues between a pair of cysteines joined by a disulfide bridge, and the number of residues between the first cysteine of each disulfide bridge and the first cysteine of the next disulfide bridge in the corresponding protein sequence.

20. The method of claim 19, wherein each disulfide signature includes the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

21. The method of claim 17, wherein generating the database includes identifying a disulfide bridge by protein sequence homology or protein structure homology.

22. The method of claim 17, wherein generating the database includes calculating a disulfide signature for a protein sequence.

23. The method of claim 17, wherein comparing includes calculating a measure of similarity between the first disulfide signature and the disulfide signature of the database.

24. The method of claim 23. wherein comnaring fiirtber includes ealeijiahing a measure of statistical relevance for the measure of similarity between the first disulfide signature and the disulfide signature of the database.

25. The method of claim 17, wherein comparing includes comparing a subpattern of the first disulfide signature to at least one disulfide signature of the database.

26. The method of claim 25, wherein the subpattern is generated by calculating the disulfide signature that results when one or more disulfide bridges is removed from the corresponding protein sequence.

27. The method of claim 17, wherein at least one disulfide signature of the database is associated with a sequence identifier.

28. The method of claim 17, wherein at least one disulfide signature of the database is associated with a domain identifier.

29. The method of claim 18, further comprising clustering the disulfide signatures of the database.

30. The method of claim 29, wherein clustering includes grouping disulfide signatures by number of disulfide bridges.

31. The method of claim 29, wherein clustering includes grouping disulfide signatures by disulfide topology.

32. The method of claim 29, wherein clustering includes calculating a measure of similarity between at least one pair of disulfide signatures and grouping based on the measure of similarity.

33. A method of detecting similarity between protein sequences comprising generating a database including a plurality of disulfide signatures, each disulfide signature being characteristic of a corresponding protein sequence.

34. The method of claim 33, wherein each disulfide signature describes a disulfide topology of the corresponding protein sequence.

35. The method of claim 34, wherein each disulfide signature includes the number of residues between a pair of cysteines joined by a disulfide bridge, and the number of residues between the first cysteine of each disulfide bridge and the first cysteine of the next disulfide bridge in the corresponding protein sequence.

36. The method of claim 35, wherein each disulfide signature includes the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

37. The method of claim 33, wherein generating the database includes identifying a disulfide bridge by protein sequence homology or protein structure homology.

38. The method of claim 33, wherein generating the database includes calculating a disulfide signature for a protein sequence.

39. The method of claim 38, wherein calculating the disulfide signature includes determining the number of residues between a pair of cysteines joined by a disulfide bridge in the protein sequence.

40. The method of claim 38, wherein calculating the disulfide signature includes determining the number of residues between the first cysteine of each disulfide bridge and the first cysteine of the next disulfide bridge in the protein sequence.

41. A computer program for detecting similarity between protein sequences, the computer program comprising instructions for causing a computer system to compare a first disulfide signature to a second disulfide signature, each disulfide signature being characteristic of a corresponding protein sequence.

42. The computer program of claim 41, wherein each disulfide signature includes the number of residues between a pair of cysteines joined by a disulfide bridge, and the number of residues between the first cysteine of each disulfide bridge and the first cysteine of the next disulfide bridge in the corresponding protein sequence.

43. The computer program of claim 42, wherein each disulfide signature includes the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

44. The computer program of claim 41, wherein comparing includes calculating a measure of similarity between the first disulfide signature and the second disulfide signature.

45. The computer program of claim 44, wherein comparing further includes calculating a measure of statistical relevance for the measure of similarity between the first disulfide signature and the second disulfide signature.

46. The computer program of claim 41, wherein comparing includes searching a database including a plurality of disulfide signatures, each disulfide signature of the database characteristic of a corresponding protein sequence.

47. The computer program of claim 46, wherein searching the database includes searching with a subpattern of the first disulfide signature.

48. The computer program of claim 47, wherein the subpattern is generated by calculating the disulfide signature that results when one or more disulfide bridges is removed from the protein sequence corresponding to the first disulfide signature.

49. The computer program of claim 46, wherein at least one disulfide signature in the database is associated with a sequence identifier.

50. The computer program of claim 46, wherein at least one disulfide signature in the database is associated with a domain identifier.

51. The computer program of claim 46, further comprising clustering disulfide signatures of the database.

52. The computer program of claim 51, wherein clustering includes grouping disulfide signatures by number of disulfide bridges.

53. The computer program of claim 51, wherein clustering includes grouping disulfide signatures by disulfide topology.

54. The computer program of claim 51, wherein clustering includes calculating a measure of similarity between disulfide signatures and grouping based on the measure of similarity.

55. A computer-readable data storage medium comprising a data storage material encoded with a computer-readable database, the database comprising a plurality of disulfide signatures, each disulfide signature of the database characteristic of a corresponding protein sequence.

56. The data storage medium of claim 55, wherein each disulfide signature of the database describes a disulfide topology of the corresponding protein sequence.

57. The data storage medium of claim 55, wherein each disulfide signature includes the number of residues between a pair of cysteines joined by a disulfide bridge, and the number of residues between the first cysteine of each disulfide bridge and the first cysteine of the next disulfide bridge in the corresponding protein sequence.

58. The data storage medium of claim 57, wherein each disulfide signature includes the number of residues between each pair of cysteines joined by a disulfide bridge, and the number of residues between the first cysteine of each disulfide bridge and the first cysteine of the next disulfide bridge in the corresponding protein sequence, for each disulfide bridge in the corresponding protein sequence.

59. The data storage medium of claim 55, wherein at least one disulfide signature in the database is associated with a sequence identifier.

60. The data storage medium of claim 55, wherein at least one disulfide signature in the database is associated with a domain identifier.

61. The data storage medium of claim 55, wherein at least one disulfide signature in the database is associated with a cluster identifier.

62. The data storage medium of claim 55, wherein the data storage material is further encoded with a computer program comprising instructions for causing a computer system to compare a first disulfide signature to a second disulfide signature, each disulfide signature being characteristic of a corresponding protein sequence.

63. The data storage medium of claim 62, wherein comparing includes calculating a measure of similarity between the first disulfide signature and the second disulfide signature.

64. The data storage medium of claim 63, wherein comparing further includes calculating a measure of statistical relevance for the measure of similarity between the first disulfide signature and the second disulfide signature.

65. The data storage medium of claim 62, wherein comparing includes searching the database.

66. The data storage medium of claim 65, searching the database includes searching with a subpattern of the first disulfide signature.

67. The data storage medium of claim 66, wherein the subpattern is generated by calculating the disulfide signature that results when one or more disulfide bridges is removed from the protein sequence corresponding to the first disulfide signature.

68. A method of describing a protein sequence comprising generating a first disulfide signature, the disulfide signature describing the cysteine spacing and disulfide topology of first a protein sequence.

69. The method of claim 68, further comprising identifying a disulfide bridge by protein sequence homology or protein structure homology.

70. The method of claim 68, further comprising generating a second disulfide signature, the signature describing the cysteine spacing and disulfide topology of a second protein sequence.

71. The method of claim 70, further comprising comparing the first disulfide signature to a second disulfide signature.

72. The method of claim 71, wherein comparing includes calculating a measure of similarity between the first disulfide signature and the second disulfide signature.

73. The method of claim 71, further comprising generating a database including the first and second disulfide signatures.
